(19) United States
(12) Patent Application Publication
(10) Pub. No.: US 2020/0051112 A1
(43) Pub. Date: Feb. 13, 2020

(54) DETERMINING PRE-SELECTIONS FOR ENROLLING IN EQUITY REWARDS BASED ON PURCHASE BEHAVIOR

(71) Applicant: Bumped, Inc., Portland, OR (US)

(72) Inventors: David Nelsen, Lake Oswego, OR (US); Philip Bryan Hagen, Portland, OR (US); Jeffrey Press, Portland, OR (US); Aaron Wirick, Portland, OR (US); Cameron Knight, Portland, OR (US); Jason Zeiber, Scappoose, OR (US)

(21) Appl. No.: 16/537,472

(22) Filed: Aug. 9, 2019

Related U.S. Application Data
(60) Provisional application No. 62/717,741, filed on Aug. 10, 2018.

(51) Int. Cl. G06Q 30/02; G06Q 40/06

(52) U.S. Cl. CPC G06Q 30/0216; G06Q 40/06; G06Q 30/0226

(57) ABSTRACT

Herein disclosed are systems and methods for distributing equity rewards to users of a loyalty platform based on tracked user loyalty purchases, where the equity rewards are provided for businesses that are automatically selected based upon information regarding a transaction history of the user and/or demographics of the user. The disclosed systems and methods may enable a reduction in time in signing up for equity rewards for one or more businesses. The disclosure is further directed to determining a business associated with a transaction using information associated with the transaction from a third-party data aggregator/integrator.

### CROSS REFERENCE TO RELATED APPLICATIONS

The present application claims priority to U.S. Provisional Patent Application No. 62/717,741, entitled “DETERMINING PRE-SELECTIONS FOR ENROLLING IN EQUITY REWARDS BASED ON PURCHASE BEHAVIOR,” filed on Aug. 10, 2018. The entire contents of the above-identified applications are hereby incorporated by reference for all purposes.

### FIELD

The present application relates to systems and methods for selecting businesses and distributing associated equity rewards to users of a loyalty platform based on purchase behavior.

### BACKGROUND AND SUMMARY

Conventional reward programs, such as mail-in rebates or reward points based programs, suffer because they fail to build user loyalty with a particular company in the long term. One reason for this failure is that one-time rewards, like a rebate, or a physical prize awarded after redeeming a certain number of accumulated points, do little to align the interests of the user with the interests of the rewarding company beyond a certain limited time frame. Another factor limiting the success of conventional reward programs to generate user loyalty is the effort required on the part of the user to record and/or submit proof of purchases which may be eligible for a reward, such as when a user is required to enter a code or other proof of purchase into an online account in order to receive credit/points for the purchase, or when a proof of purchase must be mailed-in in order to receive a rebate. Additionally, in points based rewards programs, points accrued often come with an expiration date or date when the points must be redeemed by, thereby placing an additional burden on the user to hurriedly redeem their points, further exacerbating the inability of such programs to maintain user loyalty over the long term. Points frequently have no real value outside the scope of a rewards program, and as such, mean little to customers in the grand scheme of their financial picture. Furthermore, rewards programs often have unrealistic goals requiring many dollars spent and points accrued in order to earn a small reward. As a further hurdle, rewards programs may be separately managed, such that a user identifies and separately enrolls in different programs for each business that is of interest to the user.

The inventors herein have developed systems and methods which may enable distribution of equity rewards to users with reduced user frustration during rewards enrollment by automatically identifying businesses in which to enroll the user. For example, to aid in creating an outstanding user experience by simplifying application set up the inventors have developed a process where a system may pre-populate user rewards selections based upon a near real-time computer analysis of prior spending on a payment card or within a depository account the user has linked to within a client application, just seconds prior during account set up. In an example, the user will see the results of that analysis as pre-selected businesses and/or merchants and be presented with a confirmation button and text that informs the user of the ability to make changes, corrections, or void a category all together, along with a disclosure that informs the user that pre-populated businesses and/or merchants are based upon observed prior spending habits and do not constitute investment recommendations.

In a first example, a method for enrolling a user in one or more equity rewards programs comprises, receiving from a third-party aggregator a transaction history for one or more financial accounts associated with the user, determining a first set of businesses associated with transactions in the transaction history, generating an equity rewards list including one or more businesses selected from the first set of businesses, displaying, via a display of a user device, the equity rewards list and a request to confirm the one or more businesses included in the equity rewards list, and responsive to receiving user input at the user device confirming the equity rewards list, enrolling the user in a respective equity rewards program for each business in the equity rewards list. In this way, delays in enrollment may be reduced, as the method may not rely upon a user scrolling through large lists of available rewards programs to make selections. Furthermore, the example method allows for continuous updates to rewards program enrollment as new transactions are performed. For example, responsive to detecting a new transaction for a selected business, the method may further include outputting a request for the user to confirm enrollment in a rewards program associated with the selected business. The request may be presented responsive to the first transaction for that business, or responsive to determining that a threshold number or percentage of transactions (e.g., in a given category associated with the type of the business) have been performed, in some examples. It may also occur later, in the event the consumer changes purchase behavior, and the loyalty platform detects a higher degree of loyalty to another business. In this case, the request may be presented to the consumer to suggest a change in loyalty based upon a “loyalty review” process (examining the consumer's transaction behavior and presenting recommendations via a GUI display).

In a second example, some of the above issues may be addressed by a computing system including a processor, a display, and a memory storing instructions executable by the processor to receive, from a user, information regarding a financial account to be linked to a loyalty rewards platform account, receive, from a third-party aggregator, a transaction history for one or more financial accounts associated with the user, determine a first set of businesses associated with transactions in the transaction history, generate an equity rewards list including one or more businesses selected from the first set, display, via the display, the equity rewards list and a request to confirm the equity rewards list, and responsive to receiving user input at the user device confirming the equity rewards list, enroll the user in a respective rewards program for each business in the equity rewards list. In this example, the user may be eligible to receive an equity reward associated with each business in the list of businesses and is excluded from receiving equity rewards associated with each business not included in the list of businesses.

In a third example, some of the above issues may be addressed by a method including: receiving by a transaction inspector a transaction history, generating by the transaction inspector a transaction profile that identifies businesses attributed to transactions in the received transaction history, linking by the transaction inspector the transaction profile to the received transaction history, and, for each of the businesses identified in the transaction profile, enrolling the user in a respective rewards program associated with the respective business. In this way, the example method may perform a behavior-based approach to enrolling a user in rewards programs, in which user behaviors (e.g., spending habits) are derived based on transaction history information and used to determine businesses that have rewards programs that the user may be interested in joining. In the example method, further businesses may be identified by analyzing demographic information for the user and correlating businesses with the demographic information to generate a demographic profile that identifies businesses that are associated with other users that are similar to the user. For example, the method may further include generating a confidence score indicating a likelihood that a given business will be of interest to the user based on a correlation between demographic information for the user and demographic information for users that are enrolled in a rewards program for the given business.

In a fourth example, some of the above issues may be addressed by a method including determining a common behavior set including one or more of a purchase behavior of a user and demographic information of the user, displaying a correlation result including a group of businesses, each business in the group of businesses selected based on a match of a respective profile of the business to the common behavior set, receiving a user selection of one or more businesses in the group, and, for each of the businesses selected by the user selection, enrolling the user in a respective rewards program associated with the respective business.

In a fifth example, some of the above issues may be addressed by a method including, responding to a first brand/business discontinuing a rewards program operated through the loyalty platform by automatically selecting one or more additional brands and prompting a user to make a loyalty selection to one of the one or more additional brands, wherein the one or more additional brands have active loyalty programs operated through the loyalty platform, and wherein the user had an active loyalty selection to the first brand/business when the first brand/business discontinued the rewards program. The automatically selected additional brands may be selected by the loyalty platform based on a purchase history of the user. The one or more additional brands may be designated within a same market/category of the loyalty platform. In this way, a loyalty platform may intelligently select one or more new brands for a user to select loyalty to based on the actual spending habits of the user upon responsive to a first brand ending a rewards program, thereby enabling the user to continue to earn rewards through user loyalty purchases. This may reduce user frustration upon realizing that a brand to which they have previously selected loyalty is no longer offering loyalty rewards. This may further reduce an amount of time/effort a user may exert in finding and selecting a new brand to begin earning rewards with.

The above summary is provided to introduce a selection of concepts in a simplified form that are further described below in the Detailed Description. This summary is not intended to identify key features or essential features of the subject matter, nor is it intended to be used to limit the scope of the subject matter. Furthermore, the subject matter is not limited to implementations that solve any or all of the disadvantages noted above or in any part of this disclosure.

### BRIEF DESCRIPTION OF THE DRAWINGS

FIG. 1A shows an example of a loyalty platform.

FIG. 1B shows an example of a computing system implementing the loyalty platform.

FIGS. 2A and 2B show flowcharts for an example method of signing up for a loyalty platform.

FIG. 3 shows a flowchart for an example method of generating an auto-select list of businesses having loyalty rewards programs in which a user is to be enrolled.

FIG. 4 schematically shows example communications between systems involved in loyalty rewards program enrollment.

FIG. 5 shows an example diagram of a transaction tagging method.

FIG. 6 shows an example timeline for distributing fractional equity rewards to users of a loyalty platform.

FIGS. 7-12 show example graphical user interfaces for creating a new account with the loyalty platform.

FIGS. 13-16 show example graphical user interfaces for linking a payment medium with the loyalty platform.

FIGS. 17-27 show example graphical user interfaces for submitting a brokerage account application.

FIG. 28 shows an example graphical user interfaces associated with an account sign up process of the loyalty platform.

FIGS. 29-31 show example graphical user interfaces associated with generating an auto-select list of loyalty rewards programs and associated businesses.

### DETAILED DESCRIPTION

The following description relates to systems and methods for a loyalty platform, such as a loyalty platform that provides equity rewards and/or fractional equity rewards to users based on tracked user loyalty purchases (the term “user” or “users” is herein used interchangeably with the terms “customer” or “customers”). Examples of a loyalty platform and related features are disclosed in U.S. Provisional Patent Application No. 62/697,284, entitled “DISTRIBUTING SUCCESS-LINKED REWARDS TO CUSTOMERS OF PRIVATELY HELD COMPANIES,” filed on Jul. 12, 2018, and U.S. Provisional Patent Application No. 62/543,884, entitled “DETERMINING EQUITY REWARDS BASED UPON PURCHASE BEHAVIOR”, filed on Aug. 10, 2017. The entire contents of each of the above-identified applications are hereby incorporated by reference for all purposes. The fractional equity rewards may comprise amounts of fractional shares of stock. The fractional equity rewards may comprise amounts of fractional shares of stock. As used herein, the terms fractional equity rewards, fractional shares of stock, fractional equity, fractional shares, fractional amounts of stock, fractional amounts of an Exchange Traded Fund (ETF), and similar terms shall be used interchangeably, and shall be understood to refer to positive, non-zero, non-integer amounts of shares of stock. For example, the term fractional shares of stock may refer to amounts of stock such as 1.2 shares, 0.00040 shares, 0.017397 shares, 23.7 shares, and irrational amounts of shares of stock such as pi shares, or e shares. In some example the stock may be publicly traded, and in other examples the stock may be non-publicly traded. The fractional equity reward may be provided to a user by the loyalty platform based on a tracked user loyalty purchase made at a business, wherein the business has a Merchant Agreement with the loyalty platform to provide loyalty customers of said business with rewards of equity on behalf of the business, and wherein a user loyalty purchase may comprise a purchase made by a user at a business to which the user has made a loyalty selection. As an example, the loyalty platform may have an agreement with Starbucks to reward loyalty customers of Starbucks with fractional shares of STARBUCKS stock based on purchases made by these loyalty customers. The term loyalty customer(s) as used herein (with reference to a business, company, or brand) refers to customers who have made an exclusionary loyalty selection to a brand (in this example, to Starbucks), wherein the loyalty selection may exclude the customer from receiving rewards from competing brands (competing brands may comprise brands offering similar products, or brands which operate in a same market, wherein a market is a brand category defined by the loyalty platform). As an example, Starbucks may reward loyalty customers with fractional shares of STARBUCKS stock in an amount of 2% of a monetary value of customer purchases, so, based on a customer with a loyalty selection to Starbucks conducting a purchase at Starbucks with a monetary value of $50.00, that customer may be eligible to receive $1.00 worth of STARBUCKS stock via the loyalty platform. With a current share price of STARBUCKS being $52.15/share, the loyalty customer in the above example may receive a fractional share of STARBUCKS in the amount of 0.01917 shares STARBUCKS. In examples where stocks for a given business is not publicly traded, a non-stock asset, such as a crypto asset, may be provided in a similar manner to the stocks described above. For example, a crypto asset (or a number of crypto assets) that has a value tied to a revenue of the associated business may be provided to a user as a reward, where the monetary value of a unit of the crypto asset may vary with a revenue or other valuation of the business.

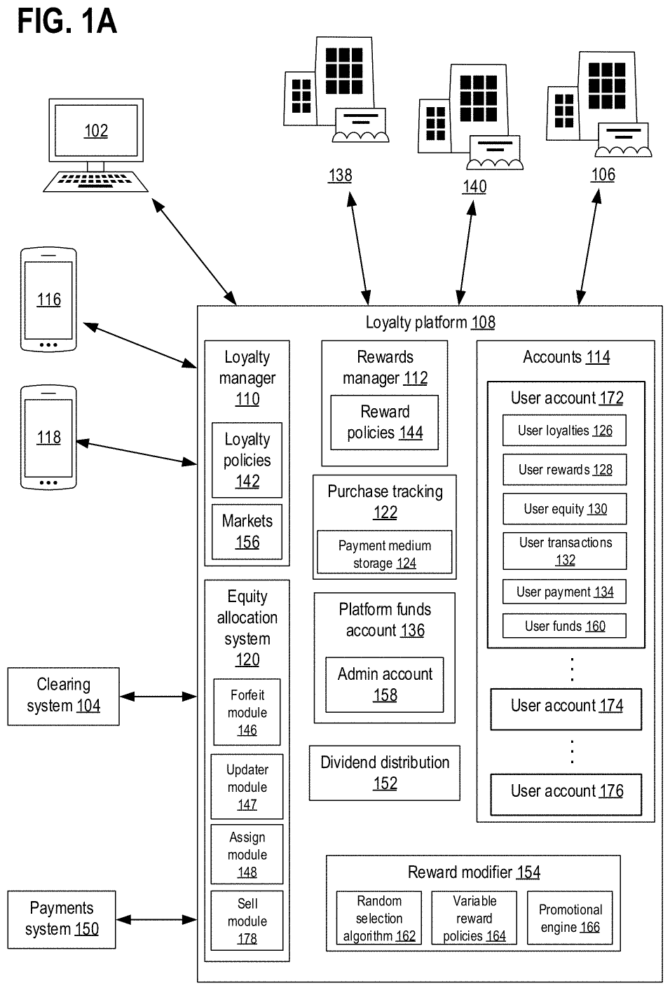

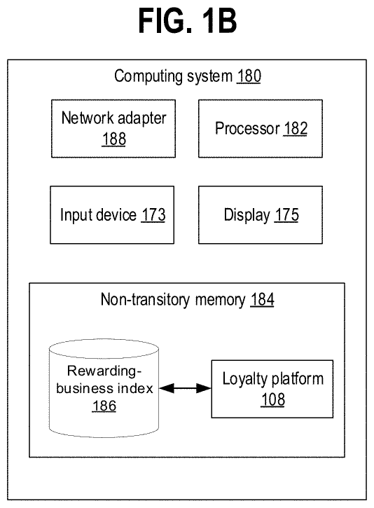

The following description provides examples of systems and methods which may enable a loyalty platform, such as loyalty platform 108 shown in FIG. 1A, to suggest businesses and/or merchants that have loyalty rewards programs in which a user may enroll. The suggestions may be targeted to a particular user based on transaction information for the user, demographic information of the user, and/or other suitable contextual information. For example, during a sign up process, payment card (e.g., credit/debit card) linking may occur relatively early on in the process. During the time between the user linking a card and the user completing details related to an associated upcoming brokerage account, there is enough time to fetch recent transaction history of the user's linked accounts. Given the raw feed of recent transactions (e.g., within approximately the last three months), an auto-selection system may categorize and analyze received information to create a tentative profile of the user. It could be determined from a resulting dataset that within the last few months, that the user has spent $X at one brand and less than half that at their closest competitor within one of the system's categories. The above determination, as well as the user's known location, age, and/or other pertinent details may be used to construct a highly-accurate representation of the brands, businesses, and/or merchants for which the user has an affinity. Once the aforementioned tentative profile is completed for the user, then a loyalty selection process can be significantly auto-filled based on the user's recent spending habits. Within a system-defined brand, business, and/or merchant category, a user's loyalty between two or more brands, businesses, and/or merchants may be too ambiguous to be automatically selected, thus prompting the system to explicitly ask the user. Also, a user might not have any spending habits within a particular brand, business, and/or merchant category. Such categories may be intentionally deemphasized to avoid clutter for the user. For other brands, businesses, and/or merchants where loyalty can be determined automatically, the user may still manually override and make a choice of brand, business, and/or merchant within a few taps.

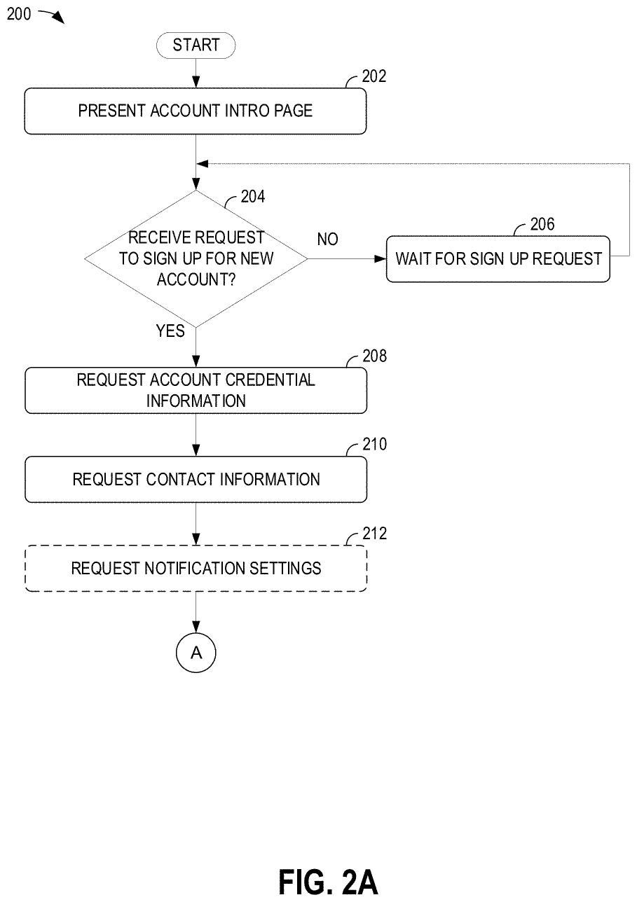

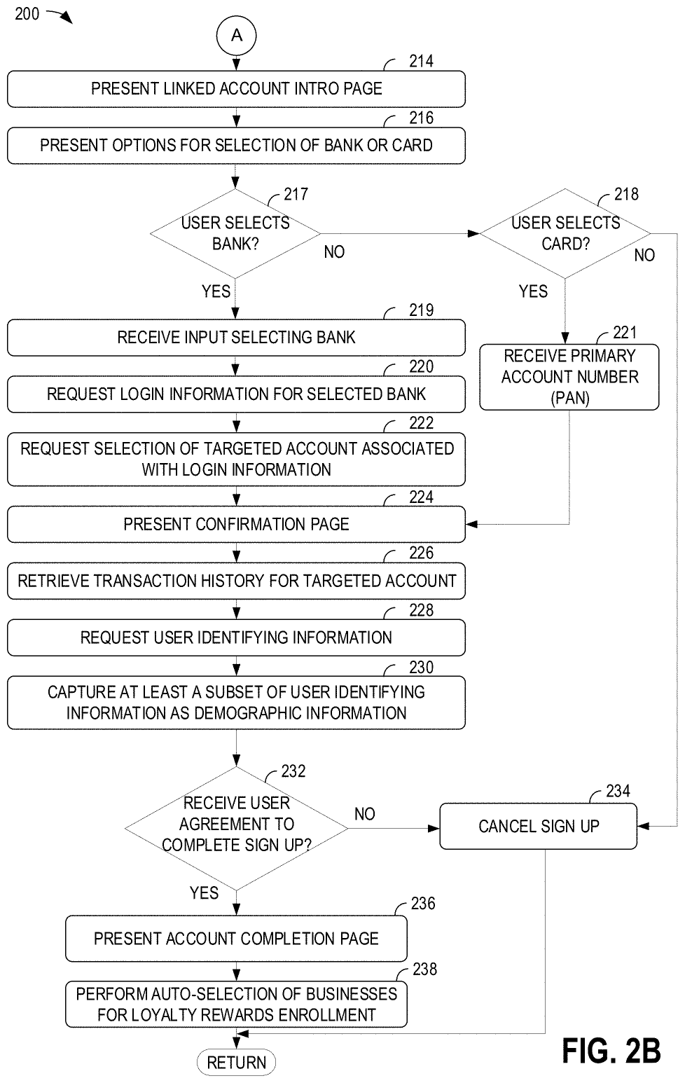

The loyalty platform may be implemented by one or more computing systems, such as computing system 180 shown in FIG. 1B. Computing system 180 may include non-transitory memory, which may include instructions that when executed carry out one or more steps of one or more of the methods herein disclosed, such as methods 200, 300, 500, and 600 described in detail below with respect to FIGS. 2A, 2B, 3, 5, and 6. It will be understood that loyalty platforms, such as loyalty platform 108 may be implemented by more than one computing system, such as in a distributed computing scheme, wherein various functionalities of the loyalty platform may be enabled by a plurality of networked computing systems working in concert. Loyalty platform 108 may comprise an equity allocation system, which may distribute fractional shares of stock to users based on tracked user loyalty purchases. It is to be understood that loyalty platform 108 is a non-limiting example of a loyalty platform used in the methods and systems described in FIGS. 2A, 2B, 3, 4, 5, and 6.

FIG. 1A schematically shows an example loyalty platform 108. Loyalty platform 108 may be implemented by one or more computing systems. In one example, loyalty platform 108 may be implemented by a server. In another example, loyalty platform 108 may be implemented by a plurality of computing systems working in concert, such as through a network connection, wherein each of the plurality of computing systems may implement part of the loyalty platform 108. Loyalty platform 108 may be configured to electronically communicate with external computing systems, such as user computing systems 102, 116, and 118, businesses 106, 138, and 140, clearing system 104, and payments system 150. In one example, loyalty platform 108 may be configured to electronically communicate with one or more additional computing systems via a network such as the Internet, wherein the electronic communication may in one example comprise transmission and reception of data between the loyalty platform 108 an one or more additional computing systems.

User computing devices 102, 116, 118, which may interface with loyalty platform 108 via a network connection, may each be associated with at least one user and further associated with at least one user account stored in non-transitory memory of one or more a computing systems implementing loyalty platform 108. As an example, use of the term “user” or “prospective user” or may refer to any legal entity, whether individual or corporate. Each user computing device may be associated with a user and thus enable the user to communicate with loyalty platform 108. In one example, user computing devices 102, 116, 118 may be associated with user accounts 172, 174, 176 and may be any associated corporation or associated individual. Users associated with user computing devices 102, 116, and 118 may register with loyalty platform 108 and make user purchases at a plurality of businesses, such as businesses 138, 140, 106. Based upon user loyalty selections, wherein a loyalty selection may comprise a selection of an exclusionary loyalty to one business in a market, the user may be entitled to a fractional equity reward upon executing a user loyalty purchase (a purchase between a user and a business with which the user has made a loyalty selection).

Additionally, the user may be excluded from receiving rewards from unselected businesses based on the loyalty selection. In one example, upon distribution of the fractional equity reward to a user account, such as user account 172 within user accounts 114 on loyalty platform 108, the loyalty platform 108 may transmit an equity reward status via network connection to the user computing device to display information pertaining to a pending fractional equity reward (as used herein, the terms pending fractional equity reward, and pending reward, refer to a fractional share of stock to which a user is entitled based on a user loyalty purchase, but which has not yet been distributed to the user). In one example, an equity reward status may indicate a current stage or state of reward distribution for a pending fractional equity reward or for a plurality of pending fractional equity rewards. In another example, an equity reward status may include an estimated reward fulfillment time for a pending fractional equity reward, such as an expected date by which the pending fractional equity reward may be distributed to the user account or an estimated duration of time until one or more stages or steps of the reward distribution process are completed (for example, a stage or step of the reward distribution process may comprise one or more of calculating the fractional equity reward, aggregating the fractional equity reward, purchasing the fractional equity reward, and distributing the fractional equity reward to the user account).

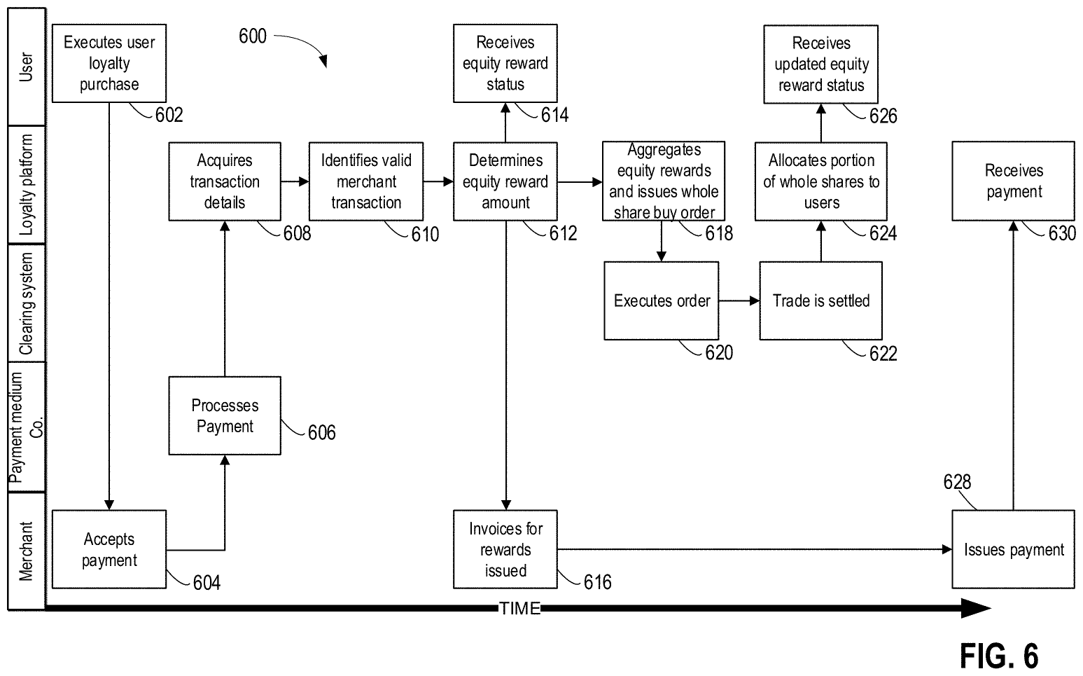

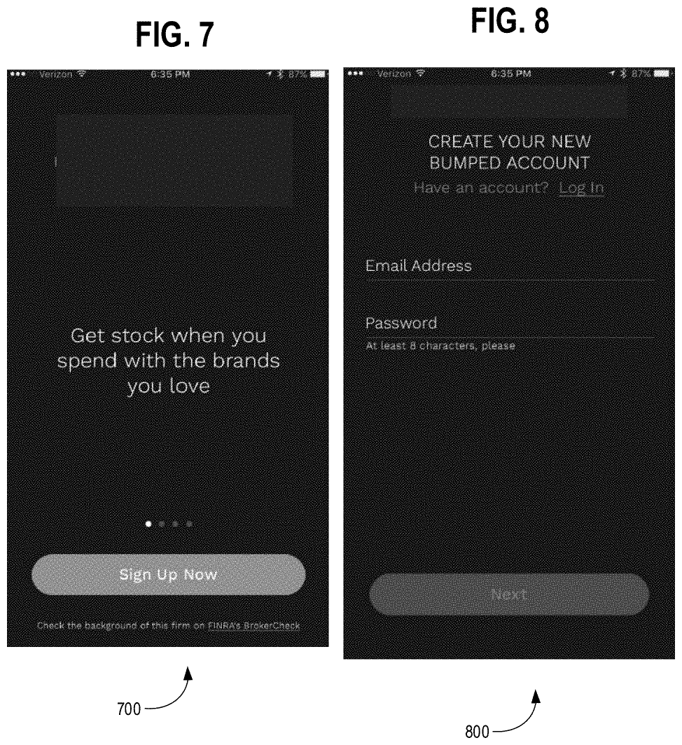

User computing devices 102, 116, 118 may each include a processor, memory, communication interface, display, user input devices, GPS/position sensors, and/or other components. In one example, a location of user computing device 116 may be determined via a GPS system associated therewith. In one example, information from loyalty platform 108 may be transmitted to user computing device 118 via a network connection (such as the Internet) between user computing device 118 and loyalty platform 108, for rendering within an interface or display implemented at user computing device 116. The display may be used to present a visual representation of the loyalty platform 108. This visual representation may take the form of a graphical user interface (GUI), examples of which are illustrated in FIGS. 6 and 7. The communication interface may communicatively couple the loyalty platform 108 with one or more other computing systems, such as the payments system 150, clearing system 104, user computing devices, and/or business computing devices. The communication interface may include wired and/or wireless communication devices compatible with one or more different communication protocols. As non-limiting examples, the communication interface may be configured for communication via a wireless telephone network, or a wired or wireless local- or wide-area network. User input device(s) may comprise one or more user-input devices such as a keyboard, mouse, touch screen, or game controller.

Clearing system 104 may comprise one or more computing devices each including a processor, memory, communication interface, and/or other components. The memory of the computing device(s) of clearing system 104 includes instructions or rules for managing a clearing house for assignment of public shares. As a further example, clearing system 104 may comprise a clearing house for assignment of non-public shares. Clearing system 104 may communicate with equity allocation system 120 of loyalty platform 108 in order to execute transactions such as the buying or selling of shares, or fractional shares, via average price account 260 of the equity allocation system 120.

Payments system 150 may comprise one or more computing devices each including a processor, memory, communication interface, network adapter, user input device(s), and/or other components. The memory of the computing device(s) of payments system 150 includes instructions or rules for disbursing and/or receiving payments via one or more banks, bank accounts, credit card accounts, checking accounts, online payments systems, or virtual wallets. In some examples, payments system 150 may include discrete accounts, each of which may be associated with a user account 172, 174, 176 of accounts 114 on the loyalty platform 108.

Businesses 138, 140, and 106 may be any merchant, business place, brand, bank, financial institution, entrepreneur or entrepreneurial entity associated with loyalty platform 108. As an example, use of the term “business” or “merchant” or “brand” may contemplate any stock corporation, whether private or public. Each business may communicate with loyalty platform 108, for example, via a business computing device. Each user computing device may include a processor, memory storing instructions executable by the processor, display, user input devices, and a communication interface.

Any of the computing devices, modules, or elements described herein with reference to FIG. 1A and FIG. 1B may communicate with each other via a network. For example, loyalty platform 108 may communicate with clearing system 104 and payments system 150 via a network.

Loyalty platform 108 may include a plurality of modules including a loyalty manager 110, rewards manager 112, accounts 114, equity allocation system 120, purchase tracking 122, platform account 136, dividend distribution 152, and reward modifier 154. As illustrated in exemplary FIG. 1B, the various modules of the loyalty platform 108 may include instructions stored in non-transitory memory 184 that are executable by processor 182 of computing system 180. In other examples, the modules may be stored on multiple memories and/or executed by multiple processors distributed across multiple computing devices connected by a network.

Loyalty manager 110 administers loyalty policies 142 and updates user loyalties 126 of accounts 114 with updated loyalty policies relating to businesses to which a user may make a loyalty selection. Loyalty manager 110 includes loyalty policies 142 and markets 156. Markets 156 may be a database or module which may further represent suitable information regarding categorization of businesses affiliated with loyalty platform 108 into discrete markets or business segments wherein the businesses segmented into different markets compete in some way or offer similar products and/or services additionally/alternatively, such information may be stored in rewarding business index 186 shown in FIG. 1B. Loyalty manager 110 may represent suitable information regarding loyalty selections of the loyalty platform 108. As a non-limiting example, loyalty manager 110 may include market definitions for a market such as “Groceries (National).” In some examples, businesses not affiliated and/or businesses pending affiliation or partnership with the platform may be listed in the markets database. In an example, businesses listed in the markets database may have different statuses such as “non-partner” (if not partnered with the platform), “partner” (if partnered with the platform), and “pending partner” (if partnership with the platform is pending). Business statuses in the markets 156 may be useful as they may allow users to be made aware of businesses which may or may not become platform partners over time, which may factor into a user's decision to make a loyalty selection to a particular business in a market. In one example, a “Groceries (National)” market might include large, nation-wide grocery chains, not limited to, for example, COSTCO, ALBERTSON'S, DOLLAR GENERAL, KROGER. In an example, a market may include any number of businesses and there may be any number of markets included in markets 156. In an example, market definitions may be defined by administrators of the platform account 136.

Additionally, loyalty manager 110 may include loyalty policies 142 which may further include instructions or information relating to managing loyalties across markets 156 of loyalty platform 108. Separating businesses into individual markets is not so simple, as many business and/or merchants exist not only in one market, but are diversified and compete in many different markets. For example, a massive big-box store such as WALMART sells not only groceries, but also home goods, including electronics, prescription medications, and clothing. As such, loyalty manager 110 may further include loyalty policies 142 that limit the loyalty selections for a user across different markets, so that a user may only select loyalty to a particular business across different markets (of markets 156) a particular number of times. In an example, a user may be allowed to select loyalty to only one business for a single market. In another example, a user may be allowed to select a first loyalty to a business in a first market and to select a second loyalty to the business in a second market. In a further example, a user may be allowed to select loyalty to a business as many times as allowed by loyalty policies 142 across different markets, if the business is “multi-listed” or offered as a loyalty selection across different markets. In a further example, a user may be allowed to select loyalty to one or more businesses listed within a market.

Further, in some examples, loyalty manager 110 may process loyalty switches of the user. In one example a user may elect to switch-loyalties after receiving a loyalty-review from the loyalty platform. In one example, a “loyalty review” may display to a user a purchase history, along with an indication of which purchases received loyalty rewards, which purchases did not receive loyalty rewards, and which purchases could have received a greater amount of loyalty rewards if a loyalty-switch was made. For example, the loyalty platform may display a “loyalty review” button within a user interface on a display of a user device, upon selection of the “loyalty review” button by the consumer, a purchase history in the grocery category (as used herein, a category of the loyalty platform is equivalent to a market of the loyalty platform) may be displayed in the user interface, wherein the purchase history may indicate that the user was spending 40% (of the total spent in the grocery category of the loyalty platform) over the last 3 months at Kroger, and 60% at Albertson's, but their loyalty is to Kroger. Based on the information displayed to the user by the loyalty review, the user may elect to switch loyalties from Kroger to Albertson's. In one example, the loyalty review may include automatically prompting a user with a loyalty-switch offer upon a determination that the user spends more with a business in a market to which the user is not currently loyal than the user spends with a business to which the user is currently loyal. In response to a user selecting a loyalty switch offer, loyalty manager 110 may update user loyalties associated with an account of a user, such as user loyalties 126 of user account 172.

Rewards manager 112 may be a module or database and may include reward policies 144 which may further include instructions or information comprising rules for providing fractional equity rewards based upon a user's selected loyalty to a transacting business (business with which transaction occurs). Additionally, reward policies 144, in an example, may include specific rule sets regarding equity rewards for a user executing purchases at or with a particular business (herein referred to as business reward policies) to which the user has selected loyalty via the loyalty platform. As an example, a user's long-term loyalty may be rewarded with increased equity rewards. In some examples, equity rewards may increase over time while in other examples, equity rewards may randomly and/or predictably vary over time. In some examples, variable, increasing, and/or long-term loyalty rewards may form stronger user-business relationships and user loyalty. Additionally, if a user switches loyalties from a first company in a first market to a second company in the first market, a promotional “loyalty-switch offer” may be made available to the user. In an example, a “loyalty-switch offer” may comprise a period of increased equity rewards per transaction with the business. For example, a “loyalty-switch offer” might also comprise any of a cash reward, discounted purchases, a set amount of equity, or any other loyalty-switch promotion desired by the administrators of the loyalty platform. As a further example, administrator account 158 or platform account 136 may modify reward policies 144 of rewards manager 112.

Accounts 114 may be a module or database including instructions, information, and/or rules relating to personal and loyalty platform information for each user 102, 116, 118 associated with the loyalty platform 108. As an example, users 102, 116, and 118 may register with loyalty platform 108 via a smartphone, computer, point-of-sale unit at businesses 106, 138, 140, or other network-enabled computing device in order to build and create user accounts 172, 174, 176 associated with (as an example) users 102, 116, and 118, respectively, the accounts being stored in accounts 114. As an example, accounts 114 may include user information for each user, including user loyalties 126, user rewards 128, accumulated user equity 130, user transactions 132, user payments 134 (including, in some examples, payment preferences, methods, or payment media), and user funds 160.

User equity 130 may include equity currently assigned to a user, such as fractional shares of stock. In one example, user equity 130 may comprise a brokerage account maintained by clearing system 104, wherein the clearing system 104 acts as the custodian of individual user equity accounts. Loyalty platform 108 may receive up-to-date information regarding user equity accounts maintained by clearing system 104, enabling the loyalty platform 108 to inform a user of the current amount of accumulated equity rewards. Further, loyalty platform 108 may communicate with clearing system 104 to conduct buys, sells, trades, or other transactions on behalf of the user. In another example, the loyalty platform 108 may maintain an omnibus account with clearing system 104, and the loyalty platform 108 may further create individual brokerage accounts/user equity accounts, such as user equity 130, maintained within the loyalty platform itself. In this example, the loyalty platform may use the omnibus account to purchase allotments of equities, which may then be journaled/distributed to individual user equity accounts to satisfy pending equity rewards.

User loyalties 126 may include the businesses and/or brands to which the user has made a loyalty selection in a defined market, and which may be displayed to a user via a graphical user interface. User rewards 128 of a user's account may include the rewards for which the user is currently eligible based on user loyalty purchases, such as when making a transaction using payment media registered (or linked) with purchase tracking 122. As used herein, payment media, or a payment medium, may refer to credit cards, debit cards, virtual wallets, or other devices capable of conducting electronic transactions, which are associated with a payment account, such as a checking account. User transactions 132 may include a history of tracked user purchases executed by a user using one or more linked payment media and tracked by loyalty platform 108 via purchase tracking 122. User payment 134 may include user preferences for payment or a virtual wallet held by the loyalty platform 108. User funds 160 may include electronic funds stored for a user which may be used for purchases made via the platform or, as an example, user funds 160 may include funds received via dividend payments from dividend distribution 152. As an example, accounts 114 may be updated continuously, via communication between rewards manager 112, loyalty manager 110, purchase tracking 122, equity allocation system 120, dividend distribution 152 and reward modifier 154, on a schedule, or in response to a trigger in order to keep user account information updated so that a user may be able to receive up-to-date information regarding their account. In an example, purchase tracking 122 may trigger a user account 172 update based upon receiving a notification of a tracked user loyalty purchase and purchase tracking may command rewards manager 112 and loyalty manager 110 to update the user account 172, such as by transmitting an equity reward status to user account 172 based on the tracked user loyalty purchase.

Equity allocation system 120 may manage purchasing, distributing, selling/liquidating, and forfeiting equity as well as updating current share prices. Equity allocation system 120 may include forfeit module 146, updater module 147, assign module 148, and sell module 178, and may be a module or database configured with rules and/or instructions for executing buy, sell, and/or forfeit orders of fractional or whole shares between loyalty platform 108 and clearing system 104 as well as, in some examples, between accounts 114 (including user accounts 172, 174, 176) and platform account 136.

Purchase tracking 122 may be a database or module configured to include instructions and rules configured to track virtual and real-world (e.g., in-store) purchases between users 102, 116, 118 and businesses 138, 140, 106. The purchase tracking system may further include payment medium storage database 124 in order to track purchases for user accounts 172, 174, 176 associated with user computing devices 102, 116, 118 who may execute transactions using payment media which have been registered (linked) and stored at payment medium storage 124. As an example, payment media stored within payment media storage 124 may include any applicable payment methods not limited to credit cards, debit cards, and online payment systems (for example, PAYPAL). In an example, payment medium storage 124 may include registration information relating to credit cards used for transactions between users and businesses. In another example, payment medium storage 124 may include registration information relating to only payments systems used for transaction between users and businesses. In another example, purchase tracking 122 may receive a notification or indication that a user has executed a transaction (for example, purchase or return).

The loyalty platform 108 may include platform account 136, which may comprise an administrator account 158 enabling platform administrators with the ability to make modifications to the loyalty platform 108, for example, adding or removing businesses to the loyalty selections available through loyalty manager 110, modifying rewards options available through rewards manager 112, modifying accounts 114, modifying equity allocation system 120, modifying dividend distribution 152, and varying the rewards provided to users at reward modifier 154.

The loyalty platform 108 may include platform account 136, which may comprise an administrator account 158 granting platform administrators with the ability to make modifications to the loyalty platform 108, for example, adding or removing businesses to the loyalty selections available through loyalty manager 110, modifying rewards options available through rewards manager 112, modifying accounts 114, modifying equity allocation system 120, modifying dividend distribution 152, and varying the rewards provided to users at reward modifier 154.

Loyalty platform 108 may also include dividend distribution 152 as a database or module comprising instructions or rules which may enable communication with clearing system 104 in order to distribute dividend payments whenever they are set to occur (such as quarterly). Clearing system 104 may, as an example, have information relating to when dividend payments are to be made and how much money or stock per share may paid-out. In one example, if a first business initiates a dividend payment process while a user holds a number of shares of stock in that business, but the user sells the number of shares of stock in the business before the dividend is received by the loyalty platform (such as may occur upon a user selecting to switch loyalty from the first business to a second business), once the dividend is received by the loyalty platform the loyalty platform may offer that dividend to the user as a cash reward (if the dividend comprises cash) or as an equity reward (if the dividend comprises an amount of shares of stock), the loyalty platform may further offer the user an option to redistribute the received dividend. Dividend payments handled by dividend distribution 152 may, in some examples, be sent to user funds 160 in user account 172. In another example, dividend payments handled by dividend distribution 152 may be sent directly to payments 150 via instructions included at user funds 160 to send payment to an account with payments 150 associated with user account 172.

Reward modifier 154 may be a module or database containing instructions configured to provide a reward modification to the normal reward, based upon random selection or based upon one or more actions taken by the user, such as a loyalty switch, accumulating more than a threshold amount of loyalty rewards, or further based one or more policies or promotional events of the rewarding business. As an example, the user may be entitled to a reward, or a normal reward, based upon the user's loyalty selection to a business, and, the normal reward may be modified based upon variable reward policies (discussed herein) to form a modified reward. As explained herein, when a user 102, 116, 118 executes a transaction, the purchase tracking 122 notifies reward modifier 154 of the transaction (which may have been made between a user and business wherein the user had made a loyalty selection to the business of the transaction) and further queries reward modifier 154 to see if the normal reward may receive a modified reward.

Turning now to FIG. 1B, example computing system 180 is shown. Computing system 180 may implement loyalty platform 108 alone, or in combination with other computing systems. In one example, computing system 180 may comprise a server. Computing system 180 includes display 175, input device 173, processor 182, network adapter 188, and non-transitory memory 184.

Display 175 may comprise a monitor, touch screen, projector, or any other device known in the art of computers for enabling a user to observe or sense information rendered by a digital device. Computing system 180 may have stored within non-transitory memory 184 instructions for rendering data, such as loyalty platform 108 data, within a graphical user interface which may be displayed by display 175.

Input device 173 enables a user to interface/interact with computing system 180, and may comprise one or more hardware devices, such as a mouse, keyboard, touch screen, motion tracking camera, or other devices configured to transform user motions, gestures, sounds, or other user actions into an electronic form which may enable a user to input data, or transmit, select, modify, or otherwise interact with data or data structures stored in or displayed by computing system 180.

Processor 182 may include one or more physical devices configured to execute instructions stored in non-transitory memory. For example, processor 182 may be configured to execute instructions that are part of one or more applications, services, programs, routines, libraries, objects, components, data structures, or other logical constructs included in loyalty platform 108.

Network adapter 188 may comprises one or more physical device associated with computing system 180, enabling transmission and reception of data between computing system 180 and one or more additional computing systems. Network adapter 188 may enable computing system 180 to access a local area network, and/or the Internet, and exchange data therewith, such as data which may enable tracking of user purchases and matching between transacting businesses and businesses registered with the loyalty platform (and therefor included in the rewarding-business index).

Non-transitory 184 memory includes one or more physical devices configured to hold data, including instructions executable by the processor to implement the methods and processes described herein. When such methods and processes are implemented, the state of non-transitory memory 184 may be transformed—e.g., to hold different data. The terms “module” and “program” may be used to describe an aspect of the computing system implemented to perform a particular function. The terms “module” and “program” may encompass individual or groups of executable files, data files, libraries, drivers, scripts, database records, etc. Non-transitory memory 184 includes the various files/routines/methods of loyalty platform 108 that when executed by processor 182 perform one or more of the steps herein described with reference to one or more of the disclosed methods. Computing system 180 may optionally include display(s), user input device(s), communication interface(s), and/or other components.

As shown in FIG. 1B, non-transitory memory 184 includes rewarding-business index 186. Rewarding-business index 186 may be stored within non-transitory memory 184 of computing system 180, and may comprise a database or module containing information regarding businesses registered with loyalty platform 108. In one example, rewarding-business index 186 may be used by computing system 180 in conjunction with purchase tracking 122 to quickly determine if a user purchase executed at a business is eligible for a fractional equity reward by matching a description of the transacting business, obtained by purchase tracking 122, with a description stored in rewarding-business index 186 associated with a business offering fractional equity rewards to loyalty users through loyalty platform 108.

In some examples, computing system 180 may be configured to implement a neural network or other machine learning algorithm, wherein the neural network comprises a classifier type neural network, configured to receive as input one or more details of a user transaction/purchase (also referred to as a transacting business description) and to use said input to produce as output a probability rank for one or more, or each, of the businesses stored within rewarding business index 186, wherein the probability rank indicates for a given business, the probability that the purchase occurred with said business. In other examples, computing system 180 may be configured to execute one or more machine learning algorithms capable of learning a non-linear mapping from a feature space comprising purchase details, to an output space comprising business classification scores/probabilities, wherein the learning algorithms may have access to rewarding business index 186, which includes an up to date listing of all businesses partnered with the loyalty platform.

To facilitate accurate matching between a transacting business and its associated reward program/policies implemented by loyalty platform 108, rewarding-business index 186 may include various features or pieces of data relating to the businesses listed therein. In one example, rewarding-business index 186 comprises a database with each entry therein corresponding to a unique business, wherein said entry may comprise a name/title, a link to the reward/loyalty policies established by the business, the status of the reward program associated with that business (such as “active”, “cancelled”, “pending deposit of funds”, etc.).

In one example, a business interested in offering equity rewards via loyalty platform 108 to customers to incentivize greater customer loyalty may register their business with loyalty platform 108. The registration process for businesses may include inputting information relating to the business into loyalty platform 108 and this information may be stored in non-transitory memory of computing systems implementing loyalty platform 108. In one example, business information may be stored in rewarding-business index 186 of one or more computing systems implementing the loyalty platform 108, such as computing system 180. As an example, the business information input into the rewarding-business index as part of the business registration process may include a description of the business, business payment information, business contact information, business locations/addresses, business hours of operation, markets in which the business operates (which may also be stored in markets 156), business reward policies/loyalty policies defining how a fractional equity reward is determined based on tracked user loyalty purchases (which may also be stored in one or more additional locations of loyalty platform 108, such as in loyalty policies 142, and reward policies 144), and other information which may enable the loyalty platform 108 to uniquely identify the business and operate a customer loyalty program customized for that individual business. In one example, a link to loyalty policies and/or reward policies associated with a business registered with the loyalty platform 108 may be included in an entry in rewarding-business index 186. In one example, rewarding business index 186 may contain an equation or algorithm (or a link pointing to a location in non-transitory memory wherein the equation or algorithm is stored) for determining an amount of fractional shares of stock to be allotted to a user based on a tracked user loyalty purchase conducted using a linked payment medium.

Further, rewarding-business index 186 may include product data regarding one or more products offered by one or more brands, wherein the product data may be used to match a tracked user loyalty purchase with a brand or business providing rewards through loyalty platform 108. In one example, product data may include product codes/identifiers for one or more products belonging to a brand. In a more specific example, rewarding-business index 186 may include a catalogue/database of products and product identifiers provided by one or more brands operating a loyalty program through loyalty platform 108, wherein the catalogue/database may include stock keeping unit codes (SKUs) enabling unique identification for one or more products provided by one or more brands registered with loyalty platform 108. In one example, a user may conduct a purchase with a business, wherein the business sells products from a plurality of brands, and upon execution of the purchase, the business may transmit POS data regarding the transaction to the loyalty platform, wherein the POS data may include SKU level detail regarding each of the purchased products. The loyalty platform may match the one or more purchased products with one or more brands using rewarding-business index 186 by correlating the SKU codes included within the POS data to SKU codes included in rewarding-business index 186. In one example, the rewarding business index comprises a list of product identifiers for each brand/business included therein, and upon matching an SKU code included in POS data transmitted to the loyalty platform 108 from a business with an SKU code listed under a first brand in the rewarding-business index 186 the loyalty platform 108 may determine that the user is eligible to receive a reward from the first brand. The loyalty platform 108 may, in response to matching one or more brands using the POS data, reward the user based on the reward policies of the reward programs provided by the one or more brands, and further based on the price of the one or more products purchased from the one or more brands. In another example, upon execution of a transaction between a user and a business, the business may determine which brands correspond to the one or more purchased products, and may transmit the indicated brands to the loyalty platform 108. In this way, the loyalty platform may reward a user with rewards from a plurality of brands/businesses based on a single purchase, by resolving a purchase using data of each purchased product. In some examples, based on a user purchase with a business, wherein the purchase comprises a purchase for a product from a brand, wherein both the business and the brand provide rewards through the loyalty platform, and wherein the user has an active loyalty selection to both the business and the brand, the user may receive rewards from both the business and the brand through the loyalty platform.

A business or brand listed in rewarding-business index 186 may be removed, deleted, or overwritten, upon suspension or cancellation of the equity rewards program established for that business. In another example, upon cancellation or suspension of a customer loyalty program offered by a business, a flag may be set in the entry corresponding to that business in the rewarding-business index, thereby indicating that no equity rewards may be earned based on tracked user loyalty purchases at this business at this time, thus retaining business information within the rewarding-business index and bypassing the need to re-enter information relating to said business into the rewarding-business index in the event that the customer loyalty program associated with the business is resumed at a later time.

Rewarding-business index 186 may be stored in a location of non-transitory memory 184 of computing system 180 and information stored therein may be accessed by computing system 180 upon execution by processor 182 of one or more methods stored in loyalty platform 108, some examples of which are described herein. In one example, rewarding-business index 186 may be accessed by purchase tracking 122 of loyalty platform 108 to attempt to match/correlate a description of a business with which a user recently made a purchase (herein also referred to as a transacting business description) with a description stored in rewarding-business index 186. The transacting business description, comprising data pertaining to the transacting business, may be obtained by loyalty platform 108 via a linked payment medium used to conduct the purchase, or alternatively, through a point of sale device of the transacting business which is configured to transmit purchase details to the loyalty platform, or from a third party purchase data aggregator. If the transacting business description matches a description of a business stored in rewarding-business index 186, the user may be entitled to a fractional equity reward for the tracked user loyalty purchase and one or more additional actions may be taken, such as look-up of the reward policies linked with the rewarding business. The link may be stored in rewarding business-index 186 in a location associated with the rewarding business description, the link may point to a location of non-transitory memory 184 associated with reward policies 144. Thus, rewarding-business index 186 enables computing system 180 to automatically determine if a tracked user purchase is eligible to receive a reward or may be eligible to receive a reward (such as upon a user accepting a loyalty-switch offer) without requiring the user to submit proof-of-purchase information, or perform other potentially annoying tasks employed by conventional rewards programs.

In this way, rewarding-business index 186 may enable loyalty platform 108 to rapidly and automatically determine if a tracked user purchase is in fact a tracked user loyalty purchase and is therefore eligible to receive a fractional equity reward. This may reduce the time between when a user executes a user loyalty purchase and when a fractional equity reward based on that purchase is distributed to the user compared to conventional approaches which require a user to manually input a code or other proof-of-purchase/proof-of-reward.

In order to enroll in one or more of the loyalty rewards programs described above, a user may first sign up for the loyalty platform, then select businesses (hereinafter, a “business” is to be understood to refer to a business, a merchant, a brand, and/or any other entity that may be associated with a loyalty rewards program) and/or associated loyalty rewards programs for enrollment. FIGS. 2A and 2B show a flow chart of an example method 200 for signing up for a loyalty platform. Method 200 may be performed by executing instructions at a user device (e.g., a mobile device executing a loyalty platform application) and/or a platform device (e.g., at a server and/or other device providing the loyalty platform), each of which may include one or more of the components of computing system 180 of FIG. 1B as described above. For example, the user device may include a display for presenting a graphical user interface that is used to perform the features of method 200 that involve presenting information and/or presenting a request for information. In examples where method 200 is performed using multiple devices, information relating to the actions of the method may be shared between devices.

At 202, the method includes presenting one or more account introduction pages via a graphical user interface. Turning briefly to FIG. 7, a graphical user interface 700 is shown that illustrates an example account introduction page. It is to be understood that different pages may be shown prior to account creation, which may be navigated via user input to the graphical user interface (e.g., via swiping through different pages, each page of which may provide helpful information for a new user of the loyalty platform and/or other information). As shown, the page may include both “log in” and “sign up” options that may be selected by a user.

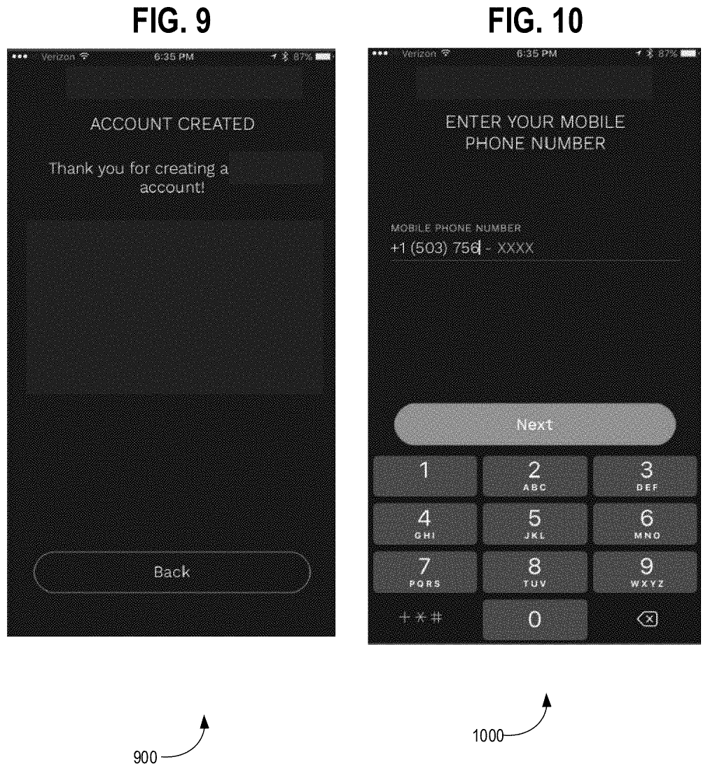

At 204, the method includes determining whether a request to sign up for a new account (e.g., a new loyalty platform account) is received. If the request is not received (e.g., “NO” at 204), the method includes waiting for a sign up request, as indicated at 206, and returns to check for the request at 204. If the request to sign up for the loyalty platform is received (e.g., “YES” at 204), the method includes requesting account credential information. The request may come from any number of sources, including partner brands, banks, the loyalty platform or other businesses. For example, via one or more different pages of a graphical user interface, the request for account credential information may include requests for an email address, a password, a confirmation of an entered email address, and/or other credentials to be used for subsequent logins to the loyalty platform. Turning briefly to FIG. 8, a graphical user interface 800 is shown that illustrates an example request for an email address to be associated with a new loyalty platform account. FIG. 9 shows a graphical user interface 900 of an example account creation page that may be shown after receiving valid account credential information (e.g., account credential information that is not associated with an existing account).

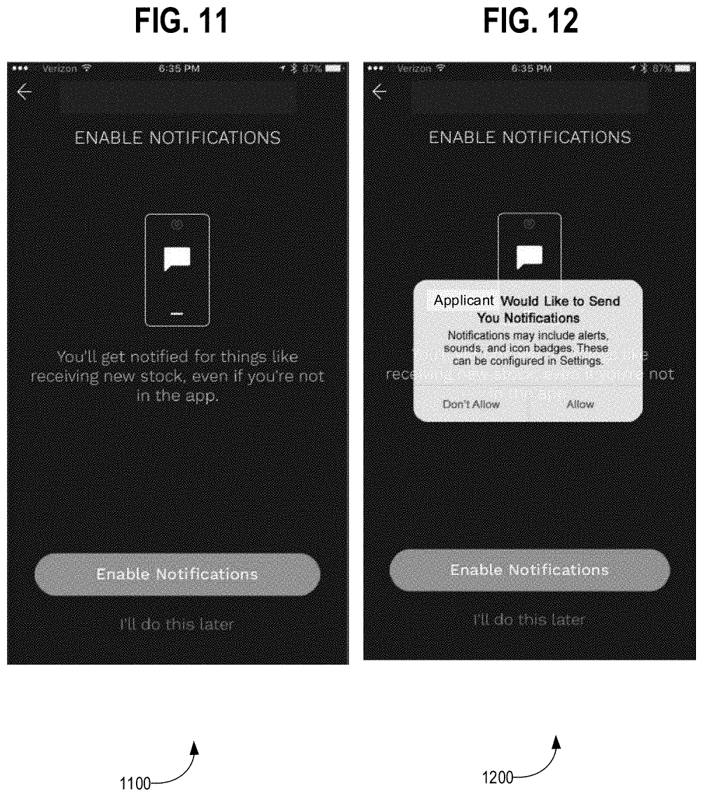

Returning to FIG. 2A, at 210, the method includes requesting contact information. For example, via one or more different pages of a graphical user interface, the request for contact information may include a request for a phone number (e.g., of a mobile phone) including a country code. Optionally, the method may include requesting notification settings, including a request to enable notifications or to skip notifications. If notifications are enabled, an operating system-specific pop-up or other confirmation screen may be displayed to confirm the selected notifications settings. In some examples, parameters of notifications may be set via a graphical user interface, such as a type of allowed notification (e.g., visual alert, audible alert, vibrating alert, etc.), a location of allowed notification, and types of alerts to provide via the notifications. Turning briefly to FIGS. 10-12, a graphical user interface 1000 is shown in FIG. 10 that illustrates a phone number entry page that may be presented during account creation. FIG. 11 shows a graphical user interface 1100 that includes an example request to enable notifications and FIG. 12 shows a graphical user interface 1200 that includes an example operating system-specific request to confirm notification settings.

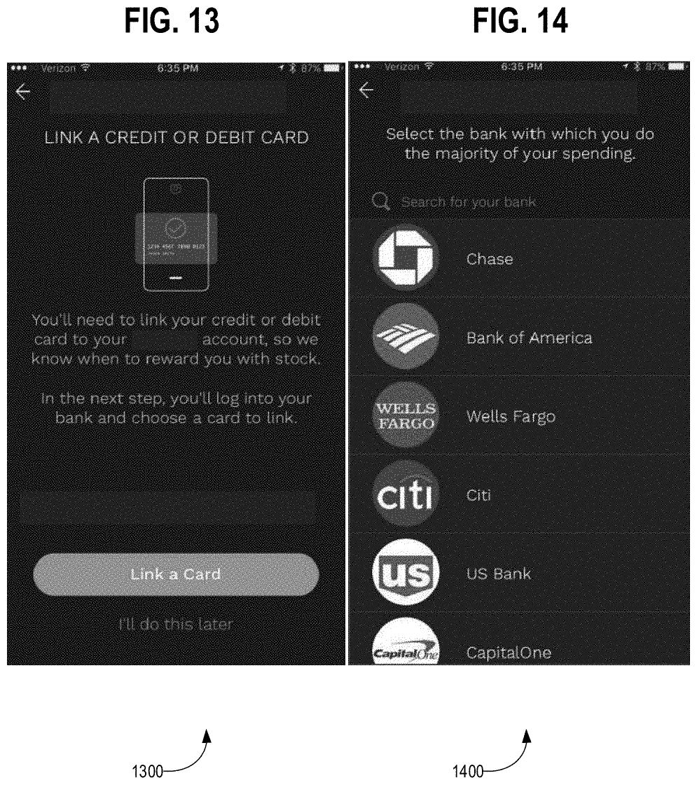

Method 200 continues in FIG. 2B with actions that are performed after a successful loyalty platform account creation. At 214, the method includes presenting a linked account introduction page. For example, the linked account introduction page may request a user to link a financial account (e.g., a debit card, a credit card, a checking account, etc.) with the loyalty platform. Purchases made via the linked account or with the linked payment card may be used to determine rewards associated with one or more selected rewards programs governed by the loyalty platform. Although a single linked account process is shown, it is to be understood that a user may link multiple accounts and/or cards to the loyalty platform and earn rewards based on purchases made via any of the linked accounts. Turning briefly to FIG. 13, a graphical user interface 1300 is shown that illustrates an example linked account introduction page including a request to begin a linked account process (e.g., via selection of “Link a Card”).

Returning to FIG. 2B, the method includes presenting, via a graphical user interface, options for selection of a bank for the linked account or selection of a payment card, as indicated at 216. In one example, the options may include multiple selectable bank identifiers and/or an option to enter a bank that is not listed. An example of a selectable list of bank identifiers is shown in graphical user interface 1400 of FIG. 14. In another example, 216 may also include displaying an option to directly enter payment card information, thereby bypassing the bank selection process.

At 217 the method includes determining if the user selected to link a bank account. In one example, the loyalty platform may determine that a user has selected to link a bank account by receiving data from a user device indicating selection of one or more banks. In another example, the loyalty platform may determine that a user has not selected to link a bank account with the loyalty platform in response to receiving data indicating input of payment card data. If at 217 it is determined that the user has not selected a bank account to link with the user loyalty platform, the method may proceed to determine if the user has instead selected to enter card information directly, as indicated at 218. If at 218 it is determined that the user has not selected to enter card information the method may proceed to cancel the sign up process, as at 234. For example, if a user has not selected a bank account or a payment card to link with the loyalty platform for a pre-determined duration of time, method 200 may proceed to 234 where the sign up process may be cancelled.

However, if at 218, it is determined that the user has selected to enter payment card information directly, method 200 may proceed to step 221. At step 221, the loyalty platform may receive payment card information. In one example, payment card information may comprise payment card data transmitted to the loyalty platform via a user device, such a cell phone, desktop computer, etc. The payment card information may comprise primary account number (PAN), which in one example may comprise a 16 digit card number uniquely identifying a payment card. In another example, the payment card information may comprise a card ID number, cryptographic signature, etc. In another example, a user may link a credit/debit card number directly from the card, which may include inputting a 16-digit PAN. Following receipt of the payment card information, method 200 may proceed directly to step 224, where a confirmation page is displayed to the user, bypassing steps 219, 220, and 222. In some examples, linking a payment card with the loyalty platform may enable the loyalty platform to receive transaction details for transactions conducted with the payment card. In some examples, the loyalty platform may receive a transaction/purchase/spend history associated with the payment card following linkage of the payment card with the loyalty platform.

Returning to 217, if at 217 the loyalty platform determines that the user has selected to link a bank account with the loyalty platform, method 200 may proceed to step 219.

At 219, the method includes receiving input selecting a bank for an account to be linked to the loyalty platform. At 220, the method includes requesting login information (e.g., username/personal identifier, password/PIN, security questions/answers, etc.) for the selected bank. An example linked account login screen is shown in graphical user interface 1500 of FIG. 15.

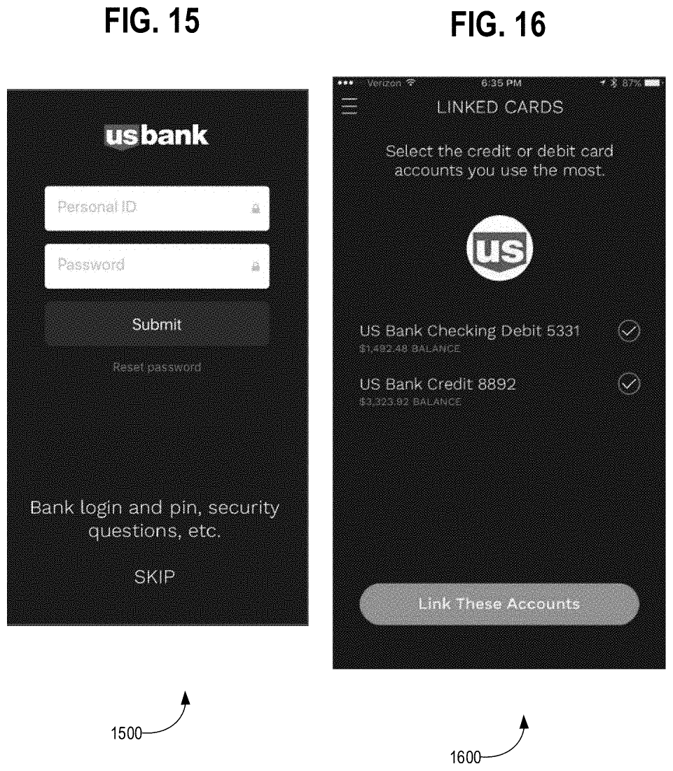

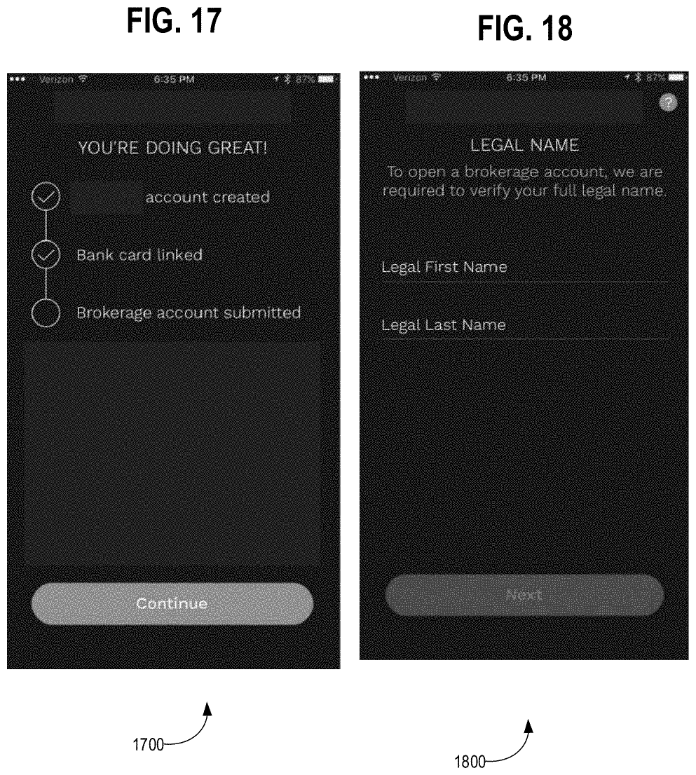

Once logged into an account to be linked to the loyalty platform account, the method includes requesting a selection of a targeted account associated with the login information, as indicated at 222 of FIG. 2B. For example, a user may have a single set of login credentials that is used for a debit card account, a credit card account, a checking account, and/or a savings account at a selected bank. The user may select which account(s) is to be linked to the loyalty platform account via a graphical user interface, such as the example selection screen shown in graphical user interface 1600 of FIG. 16. Upon selection of one or more linked accounts, a confirmation page may be presented, as indicated at 224 of FIG. 2B. An example confirmation page is shown in graphical user interface 1700 of FIG. 17. The confirmation page may also serve as a brokerage account introduction page.

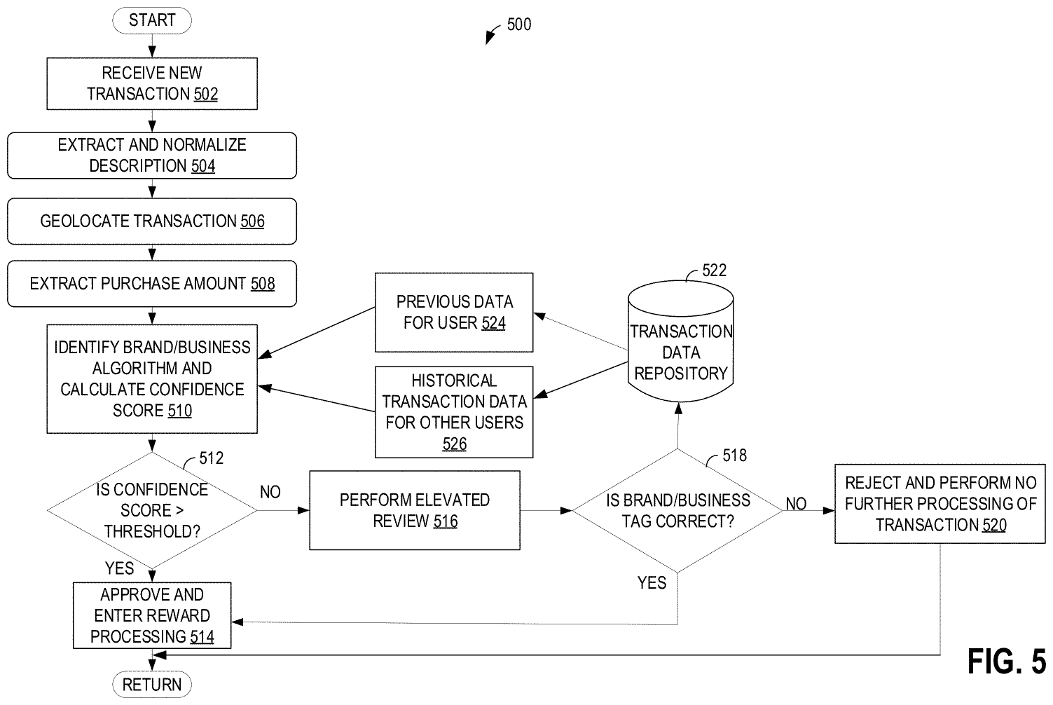

As indicated at 226 of FIG. 2B, method 200 further includes retrieving a transaction history for the targeted account(s). For example, responsive to selecting and/or confirming selection of one or more accounts to be linked to the loyalty platform account, the user device and/or a server device may request and receive information regarding recent (e.g., within a threshold amount of time, such as the prior three months) transactions for the selected one or more accounts (e.g., directly from a financial institution associated with the selected one or more accounts and/or from a third party transaction aggregator). The information may include, for each transaction made with the selected one or more accounts, a description of the transaction (e.g., as generated by a point-of-sale system at the time of the transaction), a geolocation of the transaction, an amount spent, and/or previous spending behavior of the user (e.g., associated with the transaction and/or associated with the business at which the transaction occurred). In some examples, the transaction history may identify a business at which the transaction is conducted. In other examples, the business (or an estimate of the business) at which the transaction is conducted may be derived using other information regarding the transaction (e.g., as described below with respect to FIG. 5).

After retrieving the historical transaction, the method may proceed to setting up a brokerage account. At 228, the method includes requesting user identifying information, such as a legal name (e.g., first name and last name), date of birth, an optional trusted contact, an address (e.g., a street address, optionally using a mapping application programming interface in the graphical user interface), a social security number, a citizenship (e.g., by showing a list of selectable countries), an employment status (e.g., by showing a list of selectable employment statuses), brokerage information (e.g., whether the user is an employee of the brokered account, whether the user is subject to backup withholdings by the Internal Revenue Service, whether the user is a 10% shareholder at a publicly traded company, etc.), and/or other user information (e.g., user behaviors, preferences, etc., which may be entered or derived from evaluating other information sources such as social media activity for the user). The method further includes capturing at least a subset of the user identifying information as demographic information for the user, as indicated at 230.

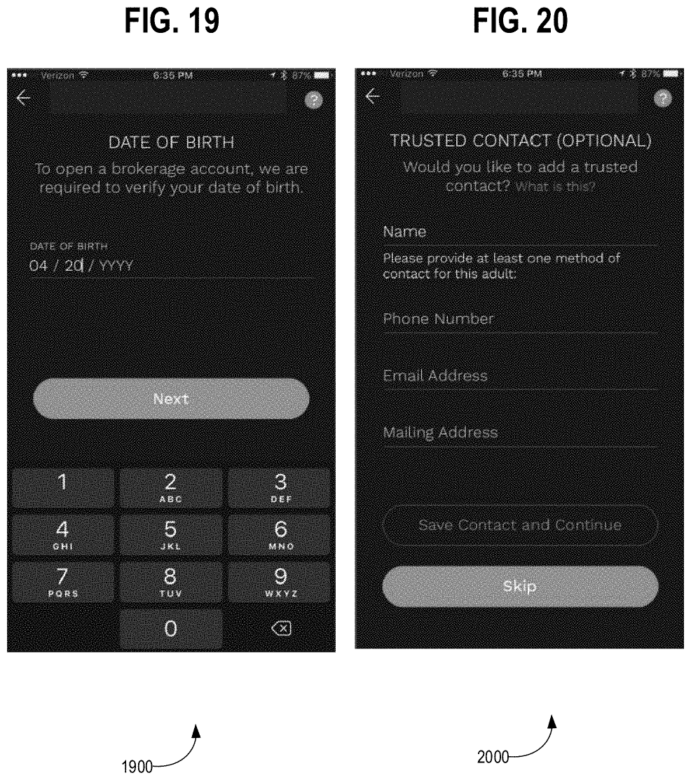

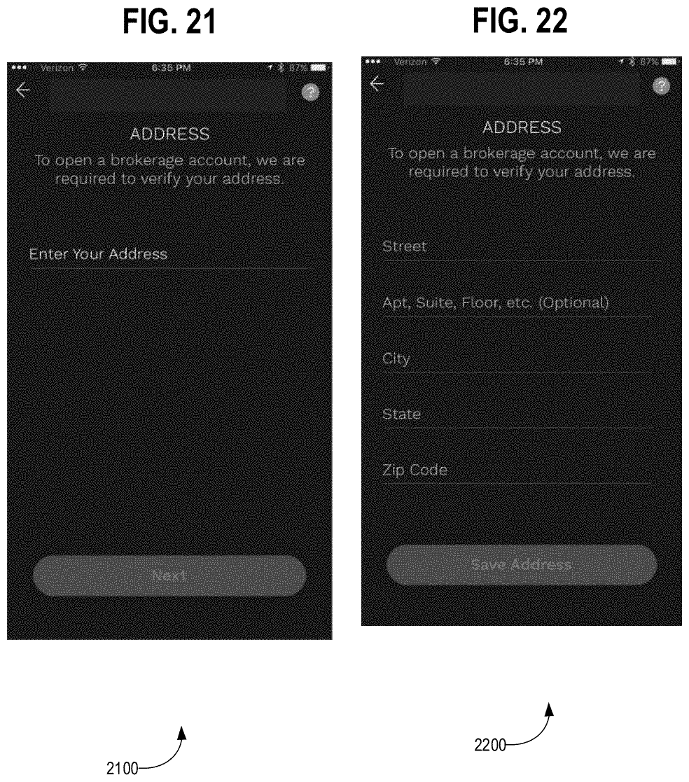

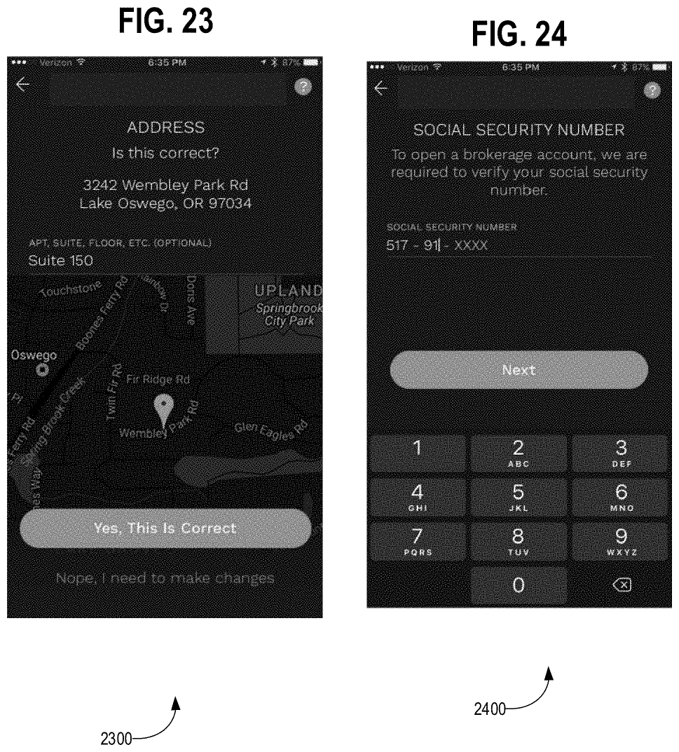

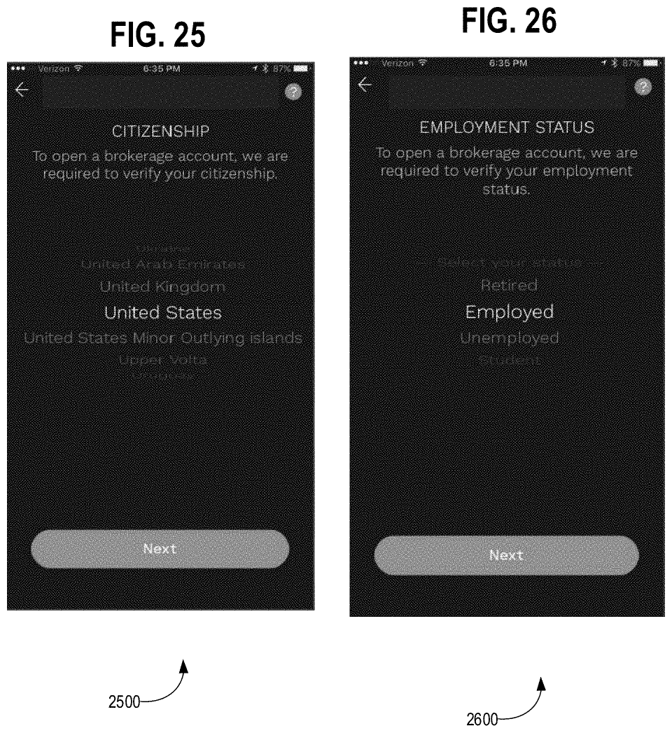

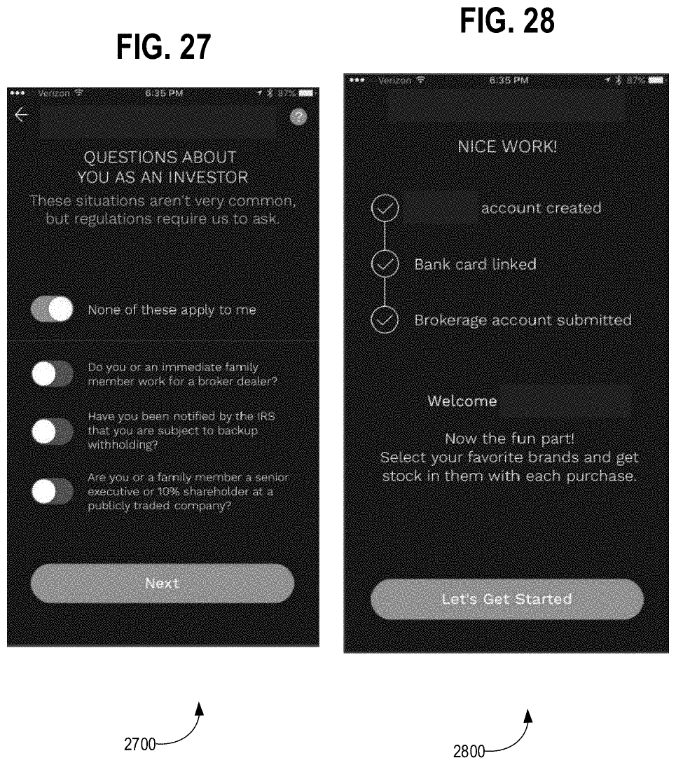

Turning briefly to FIGS. 18-29, example user interfaces for requesting and receiving entry of user identifying information are shown. FIG. 18 shows a graphical user interface 1800 illustrating an example request for a legal name and FIG. 19 shows a graphical user interface 1900 illustrating an example request for a date of birth. FIG. 20 shows a graphical user interface 2000 illustrating an example request for trusted contact information. FIGS. 21-23 show graphical user interfaces 2100, 2200, and 2300, respectively, illustrating example request and entry pages for entering an address of the user. FIG. 24 shows a graphical user interface 2400 illustrating an example request for a social security number. FIG. 25 shows a graphical user interface 2500 illustrating an example request for citizenship information including selectable country options and FIG. 26 shows a graphical user interface 2600 illustrating an example request for employment status information including selectable employment status options. FIG. 27 shows a graphical user interface 2700 illustrating an example request for brokerage information (e.g., information for the user as an investor).

Returning to FIG. 2B, the method includes determining if a user agreement to complete the loyalty platform signup is received, as indicated at 232. If a user agreement to complete the sign up is not received (e.g., if a user does not accept agreements laid out in an agreement page of the user interface, “NO” at 232), the method includes cancelling the sign up process at 234 and returning. In some examples, all entered information may be deleted as part of the cancellation at 234. In other examples, entered information may be saved for a threshold period of time after cancellation at 234 to enable a user to quickly resume signing up (e.g., in the case of an accidental cancellation). If a user agreement to complete the sign up is received (e.g., if the user accepts agreements laid out in an agreement page of the user interface, “YES” at 232), the method includes presenting an account completion page, as indicated at 236. FIG. 28 shows an example account completion page in graphical user interface 2800.

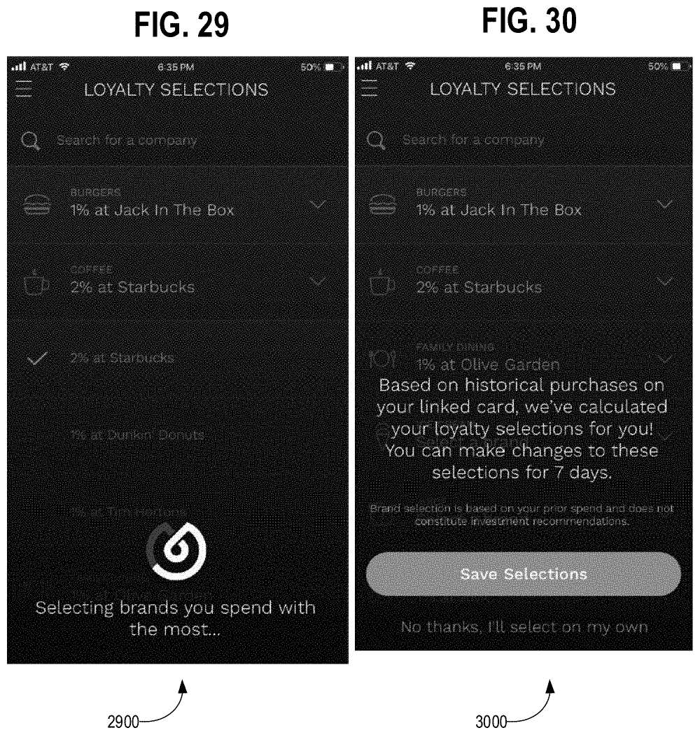

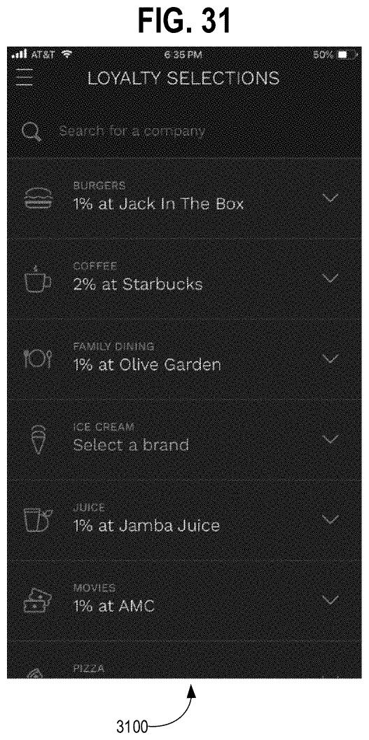

Returning to FIG. 2B, the method includes performing an auto-selection of businesses for loyalty rewards enrollment, as indicated at 238. The auto-selection of businesses may be performed by evaluating the recent transaction history retrieved at 226, the demographic information captured at 230, and/or other information (e.g., correlating businesses that match a behavior set of the user based on a profile of the businesses) and determining (e.g., based on the transaction history, demographic information, and/or other information) one or more businesses having loyalty rewards programs in which the user may be interested in enrolling. Graphical user interface 2900 of FIG. 29 shows an example pending page that may be displayed while the auto-selection of businesses is performed. Graphical user interface 3000 of FIG. 30 shows an example selection confirmation page that may be shown to allow a user to save or alter the selections loyalty enrollments. Graphical user interface 3100 of FIG. 31 shows an example list of loyalty selections made for the user (e.g., via the auto-selection of businesses at performed at 238 of method 200 of FIG. 2B).

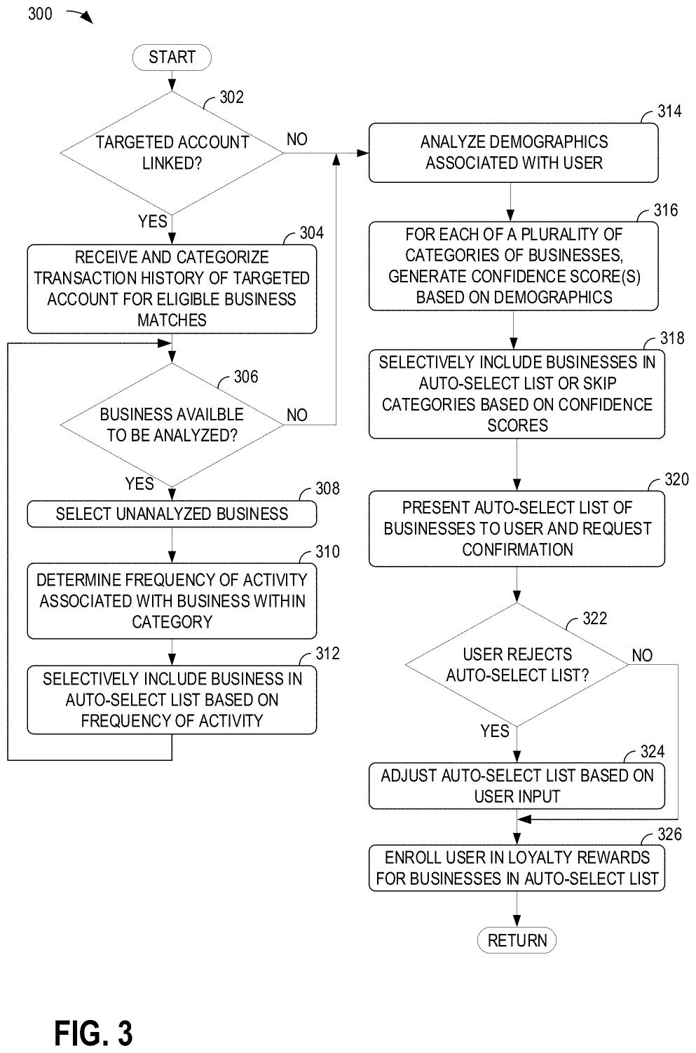

FIG. 3 shows a flow chart of an example method 300 for automatically selecting businesses and/or associated loyalty rewards programs into which a user may be enrolled. For example, method 300 may be performed to provide the auto-selection at 238 of method 200 of FIG. 2B. Method 300 may be performed by executing instructions at a user device and/or a server device, each of which may include one or more of the components of computing system 180 of FIG. 1B as described above. For example, the user device may include a display for presenting a graphical user interface that is used to perform the features of method 300 that involve presenting information and/or presenting a request for information. In examples where method 300 is performed using multiple devices, information relating to the actions of the method may be shared between devices.

At 302, the method includes determining if a targeted account (e.g., a credit card account, a debit card account, a checking account, etc.) is linked to a loyalty platform. For example, the determination at 302 may include determining if the linking process at 214-224 of FIG. 2B (or if the confirmation at 224 of FIG. 2B) was performed to link one or more financial accounts to the loyalty platform account of a user. If a targeted account is linked (e.g., “YES” at 302), the method includes receiving and categorizing a transaction history of the targeted account for eligible business matches, as indicated at 304. At 306, the method includes determining if there is a business available to be analyzed (e.g. a business identified in the transaction history). If at least one business is available to be analyzed (e.g., “YES” at 306), the method includes selecting an unanalyzed business, as indicated at 308. At 310, the method includes determining a frequency of activity associated with the selected business within a category. For example, if the transaction history indicates that a transaction was made at a particular fast food restaurant, the method may include determining how many times a transaction was made at that particular fast food restaurant relative to other fast food restaurants (e.g., whether the user visited that particular fast food restaurant more frequently than any other fast food restaurant).

At 312, the method includes selectively including the selected business in an auto-select list based at least on the frequency of activity. Using the non-limiting example above, if it is determined at 310 that the user performed more transactions at the particular fast food restaurant (or a higher value of transactions) relative to all other businesses in that category (e.g., all other fast food restaurants) and/or relative to an associated transaction threshold, then the particular fast food restaurant may be selected to be included in the auto-select list. Otherwise, if it is determined at 310 that the user performed fewer transactions (or a lower value of transactions) relative to another restaurant in the same category and/or relative to the associated transaction threshold, the particular fast food restaurant may not be selected to be included in the auto-select list. Responsive to determining if the selected business is to be included in the auto-select list, the method returns to 306 to determine if any further businesses are available to be analyzed. In this way, the method may cycle through each business indicated in the transaction history to determine whether the indicated businesses are to be included in the auto-select list. In some examples, the analysis may be performed per category of businesses, such that businesses in each category may analyzed relative to one another. In some examples, the category of businesses may be related to a market of the business (e.g., fast food, gas stations, grocery stores, etc.).

Once all businesses indicated in the transaction history have been analyzed (e.g., “NO” at 306) and/or if a targeted account is not linked (e.g., “NO” at 302), the method proceeds to 314 to analyze demographics information associated with the user. For example, the demographics captured at 230 of method 200 of FIG. 2B may be analyzed at 314. At 316, the method includes, for each of a plurality of categories of businesses, generating confidence scores based on the demographics information. For example, for each of a plurality of categories of businesses, a confidence score may be generated indicating a likelihood that a user will be interested in a selected business of the category. The confidence score may be based on interests of other users having demographic similarities to the user. For example, a business may be provided with a confidence score that is a function of a popularity of that business with users having a similar age or availability as the user, where the popularity may be based on factors such as transaction histories of the other users. At 318, the method includes selectively including businesses in the auto-select list or skipping categories based on confidence scores. For example, businesses having a confidence score above a threshold and the highest in an associated category may be included in the auto-select list. If not businesses in a given category have a confidence score above the threshold, the given category may be skipped (e.g., no business from that category may be added to the auto-select list).

At 320, the method includes presenting, via a graphical user interface, the auto-select equity rewards list of businesses (e.g., including the businesses selectively added at 312 and/or at 320, where businesses selectively added at 312 form a first set of one or more businesses and businesses selectively added at 320 form a second set of one or more businesses) to the user and requesting confirmation. At 322, the method includes determining if the user rejects the auto-select list. If the user rejects the auto-select list (e.g., the user requests to manually enter businesses and/or otherwise modify the auto-select list, “YES” at 322), the method includes adjusting the auto-select list based on user input, as indicated at 324. For example, the user may remove one or more selected businesses, add one or more selected businesses, and/or change one or more selected businesses within the auto-select list to generate an updated auto-select list. At 326, the method includes enrolling the user in loyalty rewards for businesses in the auto-select list. For example, if the user does not reject the list (e.g., the user accepts the list, “NO” at 322), the auto-select list presented at 320 may indicate all of the businesses associated with the loyalty rewards programs in which the user is enrolled at 326. If the user adjusts the auto-select list at 324, the user may be enrolled in loyalty rewards programs associated with the businesses in the updated auto-select list generated at 324. It is to be understood that the user may adjust the auto-select list at 324 to not include any businesses, which results in the user being enrolled in no loyalty rewards programs at 326.

As described above, it is to be understood that additional or alternative information may be used to determine businesses to be included in the auto-select equity rewards list. For example, the loyalty rewards platform may determine a common behavior set including one or more of a purchase behavior of a user, demographic information of the user, and/or other information of the user. In another example, the loyalty rewards platform may understand that the linked card or account is shared with another person (e.g. husband and wife with a joint card) and propose selections that match or do not match tor each account holder. In this example, there may be a rewards maximizing algorithm utilized such that each joint card holder can maximize the rewarded amount(s). The loyalty rewards platform may further determine and display a correlation result including a group of businesses, each business in the group of businesses being selected based on a match of a respective profile of the business to the common behavior set. One or more of the businesses in the group may be included in the auto-select equity rewards list. The correlation result may take into account user behaviors that may suggest features of businesses at which the user may prefer to conduct transactions using information regarding the businesses (e.g., a behavior and/or demographics of other users that have performed transactions at the business, a location(s) of the business, a size of the business, a market share of the business, a mission statement associated with the business, types and/or numbers of products and/or services sold by the business, etc.). As a more detailed, non-limiting example, a behavior set of a user (e.g., determined based upon user input and/or data gathered from third-party sources such as social media accounts for the user) may indicate that the user prefers avoiding crowds and does not travel far from home; accordingly, a correlation result may include businesses that are close to the user and are below a threshold size. Similar features may also be used to attribute a selected transaction to a particular business.

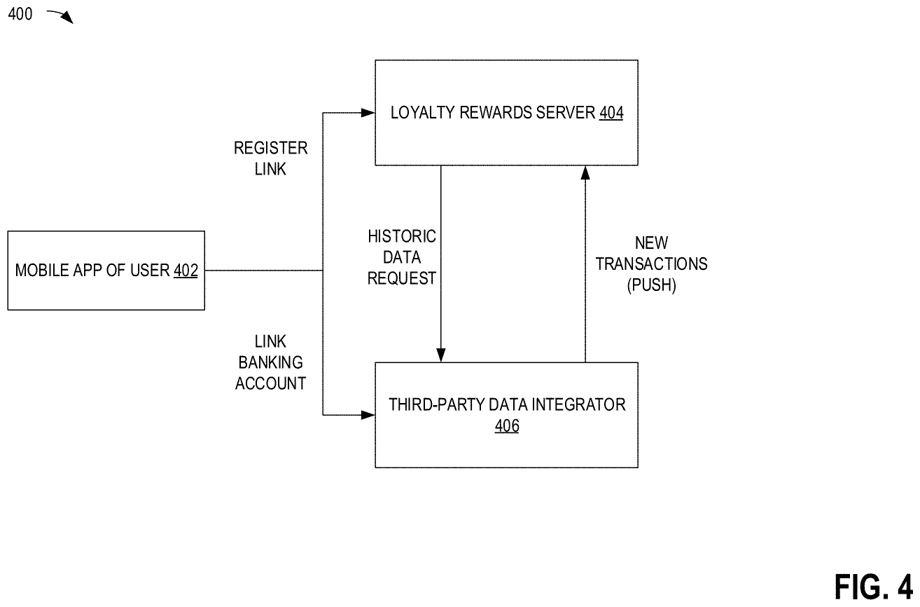

FIG. 4 schematically shows example communications between entities of a loyalty rewards system 400. The loyalty rewards system 400 may include a mobile application 402, which comprise a website or web app, of a user (e.g., executed on a mobile device of the user), a loyalty rewards server 404, and a third-party data integrator 406. As an example, the mobile application 402 may be executed on one of user computing systems 102, 116, or 118 of FIG. 1A, the loyalty rewards server 404 may include one or more computing systems that implement (e.g., execute instructions for providing) the loyalty platform 108 of FIG. 1A, and one or both of the mobile application 402 and the loyalty rewards server 404 may be used to perform the methods 200 and 300 of FIGS. 2A, 2B, and 3. The third-party data integrator 406 may be executed by a computing system that is remote from the loyalty rewards server 404 and the user device executing the mobile application 402, and may correspond to the third-part data integrator/aggregator described above.

During set up of a new loyalty rewards platform account and/or when a user adds a new financial account to an existing loyalty rewards platform account, the user may enter details of the financial account (e.g., a credit card account, debit card account, banking account, etc.) via a user interface of the mobile application 402. A registration of the linking of the financial account to the loyalty rewards platform account may be sent to both the loyalty rewards server 404 and the third-party data integrator 406. The third party integrator may be a vendor that allows a consumer to link their financial account, a merchant acquirer (e.g., a bank), a payment processor (e.g. Fiserv or FIS), a payment card network (e.g. Visa or Mastercard) or an issuing bank (typically the consumer's bank). For example, the registration may include authentication information to show that the user has authorized the loyalty rewards server 404 and the third-party data integrator to access and exchange information regarding the linked financial account.

The loyalty rewards server 404 may send a historic data request to the third-party data integrator 406 in order to retrieve a transaction history associated with the linked financial account. For example, the historic data request may correspond to the retrieval of transaction history at 226 of method 200 of FIG. 2B. In some examples, the historic data request may include a time frame of transactions requested (e.g., a last three months of transactions or a last [x] number of transactions, where x is a positive integer). The third-party data integrator 406 may send the transaction history to the loyalty rewards server 404 responsive to the historic data request. Additionally, the third-party data integrator 406 may continuously send new transactions (e.g., as push data transmissions) for the linked financial account as the transactions are performed. In some examples, the third-party data integrator 406 may send information regarding the new transactions as soon as the transactions are received by the third-party data integrator. In other examples, the third-party data integrator 406 may send information regarding the new transactions as soon as the new transactions are considered to be cleared (e.g., where no further changes are to be made to the transaction) by both parties involved in the transaction (e.g., the financial account that provided the payment and the business that received the payment).

FIG. 5 shows an example diagram of a transaction tagging method 500 that may be performed to identify a business, merchant, and/or brand associated with a transaction. In some examples, method 500 may be performed by a loyalty rewards platform, such as loyalty platform 108 and/or loyalty rewards server 404 implementing a loyalty rewards platform. At 502, the method includes receiving a new transaction. For example, as described above with respect to FIG. 4, a loyalty rewards server may receive a new transaction from a third-party data integrator/aggregator for a financial account linked to a loyalty rewards platform account. As each new transaction arrives at the loyalty rewards platform, the transaction may be automatically enriched and annotated by method 500.

The method may further include determining information regarding the transaction based on the data received (e.g., from the third-party integrator/aggregator). At 504, the method includes extracting and normalizing a description of the transaction. For example, during the transaction, information from the business receiving the payment may be associated with the transaction in order to identify the transaction. The information from the business is typically viewable by the user via account statements for the financial account, and such information may be provided to the loyalty rewards platform to assist with identifying features of the transaction. As some businesses may provide standard information formatting (e.g., a business identifier followed by a code representing a nature of the transaction, an identifier of a point of sale for the transaction, etc.), normalization may include parsing the transaction description based on known formatting styles and/or recognized portions of the description. At 506, the method includes geolocating the transaction, and at 508, the method includes extracting a purchase amount for the transaction. In this way, the loyalty rewards platform may associate a physical location and a purchase amount with the transaction. The geolocation of the transaction may be determined using information from one or more sensors of device associated with the user at the time of the transaction (e.g., a GPS sensor, an inertial measurement unit such as a gyroscope and/or accelerometer, a camera, etc.). Data from one or more sensors of devices associated with the user and/or a point of sale system involved in the transaction may be evaluated to determine a most likely location of the transaction. In other examples, the transaction history may include a notation of the geolocation of the transaction.

At 510, the method includes identifying a business, merchant, and/or brand algorithm for the transaction and calculating a confidence score that the transaction relates to a particular business, merchant, and/or brand based on the identified algorithm. Information that may be used to determine the algorithm/business and confidence score may include the description, geolocation, and purchase amount information determined at 504, 506, and 508, as well as tagging feedback information that will be discussed below. For example, the business may be narrowed down to businesses that are within a threshold distance of the geolocation associated with the transaction, and further narrowed based on a purchase amount (e.g., as discussed above, certain businesses may be associated with typical ranges of transaction amounts; as a detailed example, a $1000 transaction at a fast food restaurant would be unlikely and thus a fast food restaurant may be given a low probability of being associated with the transaction). Information in the description of the transaction may be used by comparing the description to known description formats of businesses and/or by parsing the description to determine if an identifier (e.g., a name, business ID, etc.) associated with a particular business is present. The above information may be used to determine a business that is most likely to correspond to the transaction, as well as a confidence score indicating how likely the business actually corresponds to the transaction. For example, the confidence score may be based on the amount of information used to determine the most likely business and/or the types of information that suggest the business as being the most likely business associated with the transaction. Different types of information may be given different weights for the confidence score—for example, a description that includes a name of a selected business may increase the confidence score (of that business being associated with the transaction) more than a purchase amount that falls within a typical range of transactions for the selected business (e.g., since many businesses may share similar transaction ranges).

At 512, the method includes determining if the confidence score is above a threshold. For example, the confidence score of the business that has a highest likelihood of being associated with the transaction may be evaluated at 512. If the confidence score is above the threshold (e.g., “YES” at 512), the method includes approving and entering reward processing for the transaction, as indicated at 514. For example, if the confidence score is above the threshold, rewards may be issued to the user for the business identified at 510 and based on the purchase amount extracted at 508.

If the confidence score is not above the threshold (e.g., “NO” at 512), the method includes performing an elevated review of the transaction at 516. For example, the information received at 504, 506, and 508, as well as the identified business algorithm and confidence score calculated at 510, may be provided to an enhanced processing component, such as a machine learning and/or deep learning algorithm executed by a processor and/or distributed processing system associated with the loyalty rewards platform. The elevated review may include analyzing the transaction using additional data and/or performing an audit on the transaction evaluation performed at 510. For example, the elevated review may include issuing a request for additional transaction information from one or more parties involved in the transaction, including the user associated with the linked financial account (e.g., a request for the user to confirm a business at which the transaction occurred), the financial account manager (e.g., the bank or other financial entity that manages the funds available to the linked financial account), and/or the third-party data integrator/aggregator. In additional or alternative examples, the elevated review may include a manual review of the transaction by a human operator. For example, the information received at 504, 506, and 508, as well as the identified business algorithm and confidence score calculated at 510, may be provided to the human operator for review.

At 518, the method includes determining if the business identified at 510 is correct (e.g., the transaction may be tagged at 510 with an identifier for the business determined by the loyalty platform to be most likely to be associated with the transaction). If the business is determined to be correct by the manual review (e.g., “YES” at 518), the method includes approving and entering reward processing, as indicated at 514 and described above. If the business is determined not to be correct (e.g., “NO” at 518), the method includes rejecting the association of the transaction with the business and performing no further processing of the transaction, as indicated at 520. For example, the transaction may not be processed for issuing rewards to the user. The outcome of the determination as to whether the business is correct (e.g., the outcome of 518, whether “YES” or “NO”) is provided to a transaction data repository 522. The transaction data repository 522 may be local to the loyalty platform and/or in communication with one or more computing systems associated with the loyalty platform. The transaction data repository 522 may store and provide to the loyalty platform previous data for a selected user, as indicated at 524, and historical transaction data for other users, as indicated at 526, each of which may be used in the business identification and confidence score calculation at 510. In this way, the system creates a feedback loop that learns from manual operator inputs so that weights may be adjusted to more accurately tag future transactions. In some example, a random percentage of transactions may be reviewed by operators (e.g., even if an associated confidence score is above the threshold) in order to keep the algorithm current.

Turning now to FIG. 6 an example method 600 for distributing fractional shares of stock to users of a loyalty platform based on tracked user loyalty purchases is shown. For example, method 600 may be executed in order to distribute rewards to users that have enrolled in associated loyalty rewards programs using method 200, 300, and/or 500 described above with respect to FIGS. 2A, 2B, 3, and 5. On the left side of FIG. 6, a column is displayed which indicates what agent/system performs a given step of the method. A step, indicated by a box in the flowchart, horizontally aligned (such as within a same row of a matrix) with an agent/system in the left hand column may be considered to be performed by that agent/system for purposes of example method 600. As a specific example, step 628 of method 600 is horizontally aligned with “Merchant”, which indicates that step 628 is conducted by a business registered with the loyalty platform, which may herein also be referred to as a merchant. Running along the bottom of FIG. 6, is an arrow labeled “TIME”, this arrow indicates the chronology of the steps of method 600, with steps to the right occurring later, steps to the left occurring earlier, and steps vertically aligned occurring substantially concurrently, or within a threshold duration of time of one another. For example, steps aligned vertically may occur within the same 24 hour duration of time.

Method 600 begins at 602, wherein a user executes a user loyalty purchase using a linked payment medium. The linked payment medium may comprise a credit card, debit card, other payment card, cellphone based payment app, NFC based payment system, or other types of electronic payment systems which may provide a digital record of a transaction. Method 600 may then proceed to 602.

Step 602 of method 600 includes the payment being accepted by the merchant. The merchant in this example comprises a business registered with the loyalty platform, and to whom the user (as indicated by the “user” in the left hand column of FIG. 6), has made a loyalty selection (wherein the loyalty selection may be stored in a user account associated with the user on non-transitory memory of one or more computing systems implementing a loyalty platform). Once the user's payment is accepted by the merchant, method 600 may proceed to step 604.

At step 604, method 600 may include the payment medium company processing the payment made during the user loyalty purchase. For example, in the case that the linked payment medium comprises a credit card, step 604 may comprise the credit card company processing the new charge made by the account (the account in this example referring to a user account within the credit card company) to which the user loyalty purchase was charged, and from which funds were obtained to complete the purchase. Processing of the payment may include recording one or more details associated with the user loyalty purchase, such as a date, time, and physical location of the purchase. Once the payment has been processed by the payment medium company, method 600 may proceed to step 606.

At step 606, method 600 includes the loyalty platform receiving transaction details associated with the user loyalty purchase. In one example, a third party data aggregator may compile and transmit purchase details from a plurality of different payment medium companies, such as various banks, credit card companies, etc. In another example, the payment medium company may provide purchase details directly to the loyalty platform. Method 600 may then proceed to step 608.

At step 610, method 600 includes identifying if a valid user loyalty purchase occurred based on the tracked purchase details. In one example, purchase details may be correlated with a database associated with the loyalty platform, such as rewarding-business index 186, to ascertain if the business at which the purchase occurred is registered with the loyalty platform, and currently offering fractional equity rewards to users. Further, step 610 may include looking up a user's loyalty selections, such as by identifying which user account is associated with a tracked purchase (which may be accomplished by determining which account registered a payment medium used to conduct the transaction) and then determining if the user has an active loyalty selection to the business with which the purchase was executed. If at 610 it is determined that a valid user loyalty purchase occurred, method 600 may proceed to step 612.

At step 612, method 600 includes determining/calculating a fractional share amount (a fractional equity reward) to reward the user based on the tracked user loyalty purchase. The determination may be based on a duration of user loyalty selection to the business, a transaction history of the user, a dollar amount (monetary value) of the purchase, and reward policies of the business, stored within the loyalty platform. Once a fractional share amount to reward the user has been determined, method 600 may proceed to step 614.

At step 614, method 600 includes displaying an equity reward status to the user. In one example the equity reward status may include an indication of fractional share amount to which the user is now entitled based on the recently conducted user loyalty purchase, the equity reward status may further include an indication of a timing of distribution of the fractional share amount. Method 600 may then proceed to step 616.

At step 616, method 600 includes invoicing the merchant for the dollar amount of the fractional equity reward, the invoice may further include one or more charges, such as a service fee for the loyalty platform. Method 600 may then proceed to step 628, which includes the merchant issuing a payment to the loyalty platform based on the invoice. At step 630, the loyalty platform may receive the payment from the merchant, and may allocate the received funds. In one example, a portion of the funds may be allocated to a merchant deposit account to provide future rewards of the merchant with fractional equity rewards based on user loyalty purchases.

Returning to step 612, method 600 may also proceed to 618, which includes the loyalty platform aggregating fractional equity rewards and issuing a whole share buy order with a clearing system based on the aggregated rewards. Fractional equity rewards aggregated together may comprise shares of stock in a given business, so that pending fractional equity rewards of stock X are aggregated together into a first aggregate amount, while pending fractional equity rewards of stock Y are aggregated together into a second aggregate amount, but the first and second amounts may not be aggregated together, and no aggregate amount of a mixed stocks may occur. The amount of the whole share buy order may be determined as discussed in more detail above. As one example, the whole share buy order may comprise a number of whole shares within one share of the amount of aggregated fractional equity rewards. As a specific example, based on pending fractional equity reward amount of 2.35 shares of stock X, a whole share buy order of 3.0 shares of stock X may be placed. The 3.0 shares is the rounded-up amount of the aggregated pending fractional equity rewards. Method 600 may then proceed to step 620

At step 620, method 600 includes a clearing system executing the whole share buy order placed in step 618. Method 600 may then proceed to 622. At step 622, method 600 includes the whole share buy order being filled. Method 600 may then proceed to step 624.

At step 624, method 600 includes the loyalty platform receiving from the clearing system the purchased amount of whole shares. The purchased amount of whole shares my deposited within an average price account of the loyalty platform, and may subsequently be allocated to a plurality of users to satisfy pending fractional equity rewards of the plurality of users. This may include first transferring a portion, equal to the aggregated pending fractional equity rewards, from the average price account to a merchant facilitation account, before apportioning the portion in the merchant facilitation account amongst the plurality of users. A fractional remainder of shares leftover after satisfying the pending fractional equity rewards may be purchased by, and stored within, an inventory account of the loyalty platform. Method 600 may then proceed to step 626.

At step 626, method 600 includes displaying an updated equity reward status to a user via a display of a user computing device. The updated equity reward status may indicate that an amount of fractional equity has been transferred to an account associated with the user. The updated equity reward status may further included updated totals for equity held within the account of the user on the loyalty platform. Method 600 may then end.

A technical effect of the disclosed systems and methods is an increase in efficiency and reduction of user input involved in enrolling a user in one or more loyalty rewards programs for one or more businesses by intelligently selecting relevant rewards programs and/or businesses based on information such as recent transaction history and demographic information for the user. For example, the disclosed systems and methods may economically utilize information that is already being input by the user to sign up for a loyalty platform in order to generate a list of particular loyalty rewards programs and/or associated businesses in which to enroll the user.

As an example initial setup, a loyalty platform user may create an institution link from within a loyalty platform application. The link may be stored within the loyalty platform's servers and associated with the appropriate user. The loyalty platform may (asynchronously) fetch recent and historical transactions for the aforementioned link. The loyalty platform may register with a third-party transaction aggregator to receive new transactions (e.g., associated with the institution link).

For each new transaction that is provided to the loyalty platform, the following may be performed. Based on data provided by the third-party transaction aggregator, the loyalty platform may determine the possible businesses, merchants, and/or brands to which a transaction correlates. The data may include a description of the transaction (e.g., as generated by a point-of-sale system), a geolocation of the transaction, an amount spent in the transaction (e.g., a $1000 purchase at a fast food restaurant is atypical), previous spending behavior of the user, and/or other information. A confidence score may be calculated for the transaction for businesses, merchants, and/or brands to which the transaction might be related. If the confidence score for a given business, merchant, and/or brand is high enough to not warrant elevated intervention (e.g., higher than a threshold, such as a 70% likelihood that the transaction is related to the given business, merchant, and/or brand), then the transaction is associated with that business, merchant, and/or brand. If the confidence score is below the threshold (e.g., if no business, merchant, and/or brand is given a confidence score above the threshold for that transaction) such that the system cannot accurately guarantee with which business, merchant, and/or brand the transaction is associated, elevated intervention may occur in which (in one example):
a. An operations person and/or elevated machine learning/deep learning algorithm executed within the loyalty platform manually reviews the transaction and the current confidence scores for the transaction.
b. A determination is made as to what the true business, merchant, and/or brand is to be associated with the transaction.
c. Weights are adjusted internally within the loyalty platform so that future transaction analysis is improved automatically.
   Once a transaction has been associated with one (and only one) business, merchant, and/or brand, then that information may be communicated to the end user. If the user is eligible and has opted in to receiving rewards for the associated business, merchant, and/or brand, and the transaction is in a “settled” state (indicating that the transaction will not change in the future), then a reward is allocated for transfer to the user's clearing account. In this way, the above methods and systems may also be used to categorize and attribute transactions continuously (e.g., after a user has completed loyalty platform/program signup and enrollment).

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for enrolling a user in one or more equity rewards programs comprising:
receiving, from a third-party aggregator, a transaction history for one or more financial accounts associated with the user;
determining a first set of businesses associated with transactions in the transaction history;
generating an equity rewards list including one or more businesses selected from the first set of businesses;
displaying, via a display of a user device, the equity rewards list and a request to confirm the one or more businesses included in the equity rewards list; and
responsive to receiving user input at the user device confirming the equity rewards list, enrolling the user in a respective equity rewards program for each business in the equity rewards list.

2. The method of claim 1, the method further including receiving demographic information for the user.

3. The method of claim 2, the method further comprising determining a second set of businesses associated with the demographic information.

4. The method of claim 3, wherein generating the equity rewards list further includes generating the equity rewards list including one or more businesses selected from the second set of businesses.

5. The method of claim 1, wherein enrolling the user in the respective equity rewards program for each business in the equity rewards list comprises, for each business in the equity rewards list:
receiving information defining a financial transaction between the user and the business;
based upon a value of the financial transaction, determining an equity reward for the user;
providing the equity reward to the user; and
displaying the equity reward to the user via the display.

6. The method of claim 1, the method further comprising identifying a targeted business associated with a targeted transaction by:
extracting and normalizing a description of a transaction in the transaction history;
geolocating the transaction; and/or extracting a purchase amount for the transaction.

7. The method of claim 6, further comprising generating a confidence score that the targeted business is associated with the targeted transaction based on a correlation between the targeted business and each of: the description of the transaction, the geolocation of the transaction, and the purchase amount for the transaction.

8. The method of claim 7, wherein the confidence score is determined based on previous transaction data for the user and/or historical transaction data for other users.

9. The method of claim 8, wherein the previous transaction data for the user and/or the historical transaction data for other users includes an outcome of an elevated review of a prior confidence score associated with the targeted business during an evaluation of a prior transaction.

10. The method of claim 1, the method further comprising, responsive to receiving user input at the user device rejecting the equity rewards list, receiving user input adjusting the equity rewards list to generate an adjusted equity rewards list and enrolling the user in a respective rewards program for each business in the adjusted equity rewards list.

11. A computing system, comprising:
a processor;
a display; and
a memory storing instructions executable by the processor to:
receive, from a user, information regarding a financial account to be linked to a loyalty rewards platform account;
receive, from a third-party aggregator, a transaction history for one or more financial accounts associated with the user;
determine a first set of businesses associated with transactions in the transaction history;
generate an equity rewards list including one or more businesses selected from the first set;
display, via the display, the equity rewards list and a request to confirm the equity rewards list; and
responsive to receiving user input at the user device confirming the equity rewards list, enroll the user in a respective rewards program for each business in the equity rewards list.

12. The computing system of claim 11, wherein the instructions are further executable to:
receive information defining a financial transaction between the user and a selected business included in the equity rewards list;
based upon a value of the financial transaction, determine an equity reward for the user;
provide the equity reward to the user; and
display the equity reward to the user via the display.

13. The computing system of claim 11, wherein the equity reward comprises a fractional share of stock of the selected business.

14. The computing system of claim 11, wherein the user is eligible to receive an equity reward associated with each business in the equity rewards list and is excluded from receiving equity rewards associated with each business not included in the equity rewards list.

15. A method comprising:
determining a common behavior set including one or more of a purchase behavior of a user and demographic information of the user;
displaying a correlation result including a group of businesses, each business in the group of businesses selected based on a match of a respective profile of the business to the common behavior set;
receiving a user selection of one or more businesses in the group; and
for each of the businesses selected by the user selection, enrolling the user in a respective rewards program associated with the respective business.

16. The method of claim 15, wherein, for each business in the group of businesses, the respective profile of the business includes information identifying behavior of one or more other users that has performed a transaction at the business.

17. The method of claim 15, wherein, for each business in the group of businesses, the respective profile of the business includes information identifying a category or market of the business and/or information identifying a location and/or size of the business.

18. The method of claim 15, wherein enrolling the user in the respective equity rewards program for each business in the equity rewards list comprises, for each business in the equity rewards list:
receiving information defining a financial transaction between the user and the business;
based upon a value of the financial transaction, determining an equity reward for the user;
providing the equity reward to the user; and
displaying the equity reward to the user via the display.

19. The method of claim 15, the method further comprising identifying a targeted business associated with a targeted transaction by:
extracting and normalizing a description of a transaction in the transaction history; and
extracting a purchase amount for the transaction.

20. The method of claim 15, wherein the demographic information of the user comprises one or more of a user age, a user occupation, a user address, a user marital status, and a user income level.
